(19) United States
(12) Patent Application Publication
(10) Pub. No.: US 2003/0227684 A1
(43) Pub. Date: Dec. 11, 2003

(54) Diffractive optical element, refractive optical element, illuminating optical apparatus, exposure apparatus and exposure method

(76) Inventor: Akihiro Goto, (US)

Correspondence Address: BIRCH STEWART KOLASCH & BIRCH, PO BOX 747, FALLS CHURCH, VA, 22040-0747, US

(21) Appl. No.: 10/338,717

(22) Filed: Jan. 9, 2003

(30) Foreign Application Priority Data
Jan. 9, 2002 (JP) 2002-002198

(51) Int. Cl. G02B 5/18; G02B 27/44

(52) U.S. Cl. 359/566

(57) ABSTRACT

A diffractive optical element is provided with a first basic diffractive element on which a ring-shaped diffraction grating is formed; and a second basic diffractive element on which a ring-shaped diffraction grating is formed; wherein a center of the ring-shaped diffraction grating of the first basic diffractive element is eccentric in the first direction with respect to the center of a contour of the first basic diffractive element, and a center of the ring-shaped diffraction grating of the second basic diffractive element is eccentric in the second direction with respect to the center of a contour of the second basic diffractive element.

### BACKGROUND OF THE INVENTION

1. Field of the Invention

The present invention relates to a diffractive optical element, a refractive optical element, a illuminating optical apparatus, an exposure apparatus and an exposure. In particular, the present invention relates to an illuminating optical apparatus suitable for an exposure apparatus for producing micro-devices, such as semiconductor elements, imaging elements, liquid crystal display elements, and thin film magnetic heads, by using lithography process.

2. Description of the Related Art

In a typical exposure apparatus of this type, a light beam radiated from a light source passes through a fly's eye lens to form a secondary light source, which is composed of a large number of light sources, located at a rear side focal plane of the fly's eye. The light beam from the secondary light source is limited by an aperture stop, which is disposed in the vicinity of the rear side focal plane of the fly's eye lens, before reaching a condenser lens. The aperture stop is for controlling a shape or size of the secondary light source according to predetermined illuminating condition (exposure condition).

The light beam collected by the condenser lens illuminates, in a superimposed manner, a mask on which a predetermined pattern is formed. The light beam through the pattern on the mask passes through a projection optical system to form an image on a wafer. Accordingly, the mask pattern is projected onto the wafer to be transferred thereon. The pattern formed on the mask is highly integrated. In order to correctly transfer the fine pattern onto the wafer, it is indispensable to obtain a uniform illuminance distribution on the wafer.

Recently a technique attracts the attention, in which a size of secondary light source formed on the rear side (outgoing side) of the fly's eye lens is changed by changing a size of opening of an aperture stop located on the rear side, whereby the coherency σ of illumination (.σ value=diameter of aperture stop/diameter of pupil of projection optical system, or σ value=numerical aperture on outgoing side of illumination optical system/numerical aperture on incoming side of projection optical system) can be changed. Also another technique attracts the attention, in which an aperture stop disposed on the outgoing side of the fly's eye lens has an annular or quadrupole opening for limiting the shape of secondary light source, which is to improve the depth of focus and/or the resolution of the projection optical system.

However, above described techniques limit the shape of the secondary light source to annular of quadrupole one, which leads to limitation of a light beam from the secondary light source. In other words, considerable amount of the light beam from the secondary light source is shielded by the aperture stop in those annular or quadrupole illumination, which leads to a disadvantage such as lowering of illuminance on the mask and the wafer, then resulting in lowering throughput of the exposure apparatus.

To avoid the disadvantage, the applicant proposed a technique which can form an annular secondary light source substantially without loss of light beam, for example, in Japanese unexamined patent application publication 2000-182933. FIG. 11 shows schematic diagram of main portion of a conventional illuminating optical apparatus disclosed in the publication above, where a prism (or diffractive optical element) 101b is used for converting a light beam from a light source (not shown) to a annular light beam.

The annular light beam formed by the prism 101b comes into a first fly's eye lens 104 as a first optical integrator from an oblique direction substantially symmetrically with respect to the optical axis AX via condensing optical system including lens groups 102 and 103. The light beam which passed through the first fly's eye lens 104 comes into a second fly's eye lens 106 functioning as a second optical integrator via relay optical system 105.

As shown in FIG. 12, when a circular light beam with optical axis center AX comes into a incident plane (light-incoming plane) PL1 of the prism 101b, a ring shape (ring with little width) light beam with a center of optical axis AX is formed on the pupil plane PL2 of the condensing optical system (102, 103). As shown in FIG. 13, he first fly's eye lens 104 is composed of a large number of regular hexagonal lens elements 104a having the positive refractive power arranged densely in the vertical and lateral directions.

Consequently, the light beam through one of the first fly's eye lens 104 forms regular hexagonal light beam on an incident plane PL3 of a second fly's eye 106. Finally, annular illumination fields is formed on the incident plane PL3 of the second fly's eye lens 106 by superimposing each regular hexagonal light beams on a virtual circle C1 with a center of optical axis AX. On the rear side focal plane PL4 of the second fly's eye lens 106, a secondary light source composed of substantial surface light source (surface light source consisting of a large number of light source which forms an annular shape as a whole), which has substantially the same light intensity distribution as that of the illumination field formed on the incident plane PL3 of the second fly's eye lens 106

The annular illumination field formed on the incident plane PL3 of the second fly's eye lens 106 has an illuminanse distribution shown in FIG. 14 when an illuminance distribution of a light beam incoming into a prism 101b is uniform and a cross-section of the light beam is a circle. FIG. 14 shows substantially annular shaped illumination field with a center of the optical axis AX is formed on the incident plane PL3 of the second fly's eye lens 106 and the illuminance has uneven distribution with six peaks three-times-rotation-symmetric with respect to the optical axis AX along annular ring.

By reference to FIG. 15 is explained cause of non-uniform illuminance distribution of the annular illumination field. Reference mark Cl shows a virtual circle with a center of optical axis AX which is set in the annular illumination field formed on the incident plane PL3 of the second fly's eye lens 106. To make understand easy, only an illuminance distribution on the virtual circle Cl is discussed.

In the case where each light beam from a great number of light source formed on a rear side focal plane of the first fly's eye lens are superimposed on the virtual circle C1 shown in FIG. 15(a), how much each light beams has an effect on the illuminance distribution on the virtual circle depends on a shape of effective area of the lens element 104a which composes the first fly's eye lens 104. That is the illuminance distribution on the virtual circle C1 is represented by an along-C1 integration of the length of line segment which is a portion of tangential line of the circle located within a regular hexagon optically corresponding to a cross-section of the lens element 104a.

For example, assuming that a light beam from a lens element 104a forms a regular hexagonal light beam L1, corresponding to the cross-section of the element 104a, on an incident plane PL3 of the second fly's eye lens 106, and another light beam from another lens element 104a makes another regular hexagonal light beam L2 on the incident plane PL3 of the second fly's eye lens 106. As shown in FIG. 15(a), portion (line segment) of the tangential line located within the regular hexagonal light beam L1 is the longest line and portion (line segment) within the regular hexagonal light beam L2 is the shortest one.

Consequently light amount becomes maximum at a center position P1 of the light beam L1 where the portion within the regular hexagon is longest, which corresponds to the peak of illuminance distribution shown in FIG. 14. Contrary light amount becomes minimum at a center position P2 of the light beam L2 where the portion within the regular hexagon is shortest, which corresponds to the valley of illuminance distribution shown in FIG. 14. As shown in FIG. 15(b), generally the peak of illuminance distribution exists at intersection Pm of the virtual circle C1 and three line segments (shown as dashed line in the drawing) which run through the center AX of the circle C1 and each of which is perpendicular to each of diagonal lines D10, D11 and D12 of a regular hexagon F when a center of a regular hexagon, indicating an effective area shape of the lens element 104a, is superposed on the center of the virtual circle C1, i.e., optical axis AX.

Thus in the conventional technique, because of nonuniform illuminance distribution of the annular illumination field formed on the incident plane PL3 of the second fly's eye lens 106 which has an optical conjugate relationship with an illumination plane, an illuminance distribution on the illumination objective plane becomes nonuniform, which may make it impossible to have very fine pattern copied in high-fidelity. Also as an illuminance distribution of an annular secondary light source, which is formed on an illumination pupil plane of the rear focal plane PL4 of the second fly's eye lens 106, becomes nonuniform, that may make it impossible to obtain high-fidelity copies of very fine pattern.

### SUMMARY OF THE INVENTION

The present invention has been made taking the foregoing problems into consideration, an object of which is to provide a diffraction element and a refractive element which are capable of forming a substantially uniform illuminance distribution both on an illumination plane and an illumination pupil plane in an illuminating optical apparatus.

Another object of the present invention is to provide an illuminating optical apparatus, which is capable of providing a good annular illumination with less loss of light beam amount, including a diffractive optical element and a refractive optical element which are capable of forming a substantially uniform illuminance distribution both on an illumination plane and an illumination pupil plane.

Still another object of the present invention is to provide an exposure apparatus and an exposure method which are capable of making high-fidelity transfer of a mask pattern onto a photosensitive substrate under the optimal illumination condition for the mask by using an illuminating optical apparatus capable of providing a good annular illumination with less loss of light beam amount.

According to a first aspect of the present invention, the diffractive optical element comprises a first basic diffraction element on which a ring-shaped diffraction grating is formed; and a second basic diffraction element on which a ring-shaped diffraction grating is formed; wherein a center of the ring-shaped diffraction grating of the first basic diffraction element is eccentric in the first direction with respect to the center of a contour of the first basic diffraction element, and a center of the ring-shaped diffraction grating of the second basic diffraction element is eccentric in the second direction with respect to the center of a contour of the second basic diffraction element.

According to a preferable embodiment of the first aspect of the present invention, the first direction and the second direction may be substantially perpendicular to each other. An eccentricity of the center of the ring-shaped diffraction grating of the first basic diffraction element in the first direction is substantially equal to that of the second basic diffraction element in the second direction. In this case, the first basic diffraction element and the second basic diffraction element may have the same square contour of which one side is L in length, and the eccentricity A meets the following condition; 0.28L<Δ<0.30L.

According to a preferable embodiment of the first aspect of the present invention, the number of the first basic diffraction element may be substantially equal to the number of the second basic diffraction element. The first basic diffraction element and the second basic diffraction element may be alternately adjacently arrayed in the diffractive optical element.

According to a preferable embodiment of the first aspect of the present invention, the first basic diffraction element may include a first standard element on which a circular region and annular regions defined by concentric circles are formed where even-numbered regions are projection areas and a first complementary element on which a circular region and annular regions defined by concentric circles are formed where odd-numbered regions are projection areas assuming that a center is in odd-numbered region 1, and the second basic diffraction element may include a second standard element on which a circular region and annular regions defined by concentric circles are formed where even-numbered regions are projection areas and a second complementary element on which a circular region and annular regions defined by concentric circles are formed where odd-numbered regions are projection areas assuming that a center is in odd-numbered region 1.

In this case, the number of the first standard element may be substantially equal to the number of the first complementary element and the number of the second standard element may be substantially equal to the number of the second complementary element. Also the first standard element and the second standard element may be adjacently arranged to form a standard block composed of the first standard element and the second standard element, and the first complementary element and the second complementary element may be adjacently arranged to form a complementary block composed of the first complementary element and the second complementary element, wherein the number of the standard block is substantially equal to the number of the complementary block, and the standard block and the complementary block are arranged spatially in a random order. A diameter of the circular region may be substantially equal in dimension to a width of the each annular region.

According to a preferable embodiment of the first aspect of the present invention, the first basic diffraction element may include a first standard element and n types of first complementary elements, where n represents positive integer, the second basic diffraction element may include a second standard element and n types of second complementary elements, where n represents positive integer, wherein the first complementary element and the second complementary element of i^{th} phase (i=1 to n) have a pattern which radiate a light field (which is expressed by optical complex amplitude in optics) of i^{th} phase difference with respect to a light field radiated by the first standard element and the second standard element. In this case, the first basic diffraction element and the second basic diffraction element may have a plurality of types of the complementary elements respectively, and the i^{th} phase difference is may be changed with substantially the same phase interval. Furthermore, the i^{th} phase difference between the first standard element and the first complementary element of the i^{th} phase and the i^{th} phase difference between the second standard element and the second complementary element of the i^{th} phase may be substantially a wave length of i/(n+1).

According to a preferable embodiment of the first aspect of the present invention, the diffractive optical element may includes a plurality of the first standard elements, a plurality of the second standard elements, a plurality of the first complementary elements of the i^{th} phase and a plurality of the second complementary elements of i^{th} phase. In this case, a plurality of the first standard elements, a plurality of the second standard elements, a plurality of the first complementary elements of i^{th} phase and a plurality of the second complementary elements of i^{th} phase may be substantially the same in number with respect to all of i. Also a plurality of the first standard elements, a plurality of the second standard elements, a plurality of the first complementary elements of i^{th} phase and a plurality of the second complementary elements of i^{th} phase may be randomly arranged all over the diffractive optical element.

According to a preferable embodiment of the first aspect of the present invention, the diffractive optical element may have a plurality of block patterns in each of which a plurality of the first standard elements, a plurality of the second standard elements, a plurality of the first complementary elements of i^{th} phase and a plurality of the second complementary elements of i^{th} phase are randomly arranged. In this case, a plurality of the first standard elements, a plurality of the second standard elements, a plurality of the first complementary elements of i^{th} phase and a plurality of the second complementary elements of i^{th} phase may be substantially the same in number with respect to all of i in each of the block patterns. Each of the block patterns may have a different type of random arrangement from others. The ring-shaped diffraction grating may have one of patterns, binary type, blaze type or multi-level-type.

According to a second aspect of the present invention, the refractive optical element comprises a first basic refractive element composed of conical prism; and a second basic refractive element composed of conical prism; wherein a center axis of the conical prism of the first basic refractive element is eccentric in the first direction with respect to the center of a contour of the first basic refractive element, and a center axis of the conical prism of the second basic refractive element is eccentric in the second direction with respect to the center of a contour of the second basic refractive element.

According to a preferable embodiment of the second aspect of the present invention, the first direction and the second direction may be substantially perpendicular to each other. An eccentricity of the center axis of the conical prism of the first basic refractive element in the first direction may be substantially equal to that of the second basic refractive element in the second direction. The number of the first basic refractive element may be substantially equal to the number of the second basic refractive element. The first basic refractive element and the second basic refractive element may be alternately adjacently arrayed in the refractive optical element.

According to a third aspect of the present invention, the illuminating optical apparatus for illuminating an illumination plane comprises a diffractive optical element according to the first aspect of the present invention or a refractive optical element according to the second aspect of the present invention which are f or converting incoming light beam into a ring shape light beam so that a secondary light source having an annular light intensity distribution can be formed on illumination pupil plane.

According to a preferable embodiment of the third aspect of the present invention, the illuminating optical apparatus may further comprise a light source to provide a light beam; an angled-light-beam forming means for converting the light beam from the light source into a light beam having a variety of angle components with respect to the light optical axis and sending the light beam into predetermined first plane; an illumination field forming means including the diffractive optical element or the refractive optical element for forming an annular illumination field on a second predetermined plane based on the light beam having a variety of angle components with respect to the optical axis; an optical integrator for forming an annular secondary light source having substantially the same light intensity distribution as the annular illumination field; and a light guiding optical system for guiding a light beam from the optical integrator to the illumination plane.

In this case, the angled-light-beam forming means may include an optical member composed of a plurality of optical elements; and the diffractive optical element or the refractive optical element may be arranged so that a plurality of basic diffraction elements or basic refractive elements can be disposed included in an element light beam which corresponds to each optical element of the optical member, or the angled-light-beam forming means may include an optical member composed of a plurality of optical elements; and the diffractive optical element or the refractive optical element may be arranged so that a combination of the first basic diffraction element and the second basic diffraction element or a combination of the first basic refractive element and the second basic refractive element can be included in an element light beam which corresponds to each optical element of the optical member.

According to a fourth aspect of the present invention, the exposure apparatus comprises an illuminating optical apparatus according to the third aspect of the present invention; and a light projection optical system for projecting an image of a pattern of a mask disposed on the illumination plane onto a photosensitive substrate, in other words, exposing a photosensitive substrate disposed on the illumination plane with a mask pattern.

According to a fifth aspect of the present invention, the exposure method comprises steps of: illuminating a mask via the illuminating optical apparatus according to the third aspect of the present invention; and projecting an image of a pattern of the mask onto a photosensitive substrate, in other words, exposing a photosensitive substrate with a pattern formed on the mask illuminated.

According to a fifth aspect of the present invention, the diffractive optical apparatus including a diffractive optical element for converting incoming light beam into a predetermined outgoing light beam comprises a protecting member, which transmit a light, disposed in the light beam incoming side and/or light beam outgoing side of the diffractive optical element, wherein the protecting member is made of fluorite or oxide crystal.

### BRIEF DESCRIPTION OF THE DRAWINGS

FIG. 1 shows schematic diagram of an exposure apparatus including an illuminating optical apparatus according to an embodiment of the present invention.

FIG. 2 schematically shows a whole structure of a diffractive optical element used for annular illumination in this embodiment.

FIG. 3 schematically shows a structure of a first basic diffraction element included in the diffractive optical element used for the annular illumination of the embodiment.

FIG. 4 schematically shows cross sectional views of a first basic diffraction element and a second basic diffraction element included in a diffractive optical element used for annular illumination in this embodiment.

FIG. 5 schematically shows a structure of a second basic diffraction element included in the diffractive optical element used for the annular illumination of this embodiment.

FIG. 6 is a first explanatory diagram of intensity distribution characteristics of a diffractive optical element for annular illumination in this embodiment.

FIG. 7 is a second explanatory diagram of intensity distribution characteristics of a diffractive optical element for annular illumination in this embodiment.

FIG. 8 schematically shows a whole structure of a usable refractive optical element in substitution for a diffractive optical element used for annular illumination in this embodiment.

FIG. 9 is a flow chart of manufacturing process of semiconductor device as one of micro-devices.

FIG. 10 is a flow chart of manufacturing process of liquid crystal display device as one of micro-devices.

FIG. 11 shows schematic diagram of main portion of a conventional illuminating optical apparatus disclosed in the Japanese unexamined patent application publication 2000-182933.

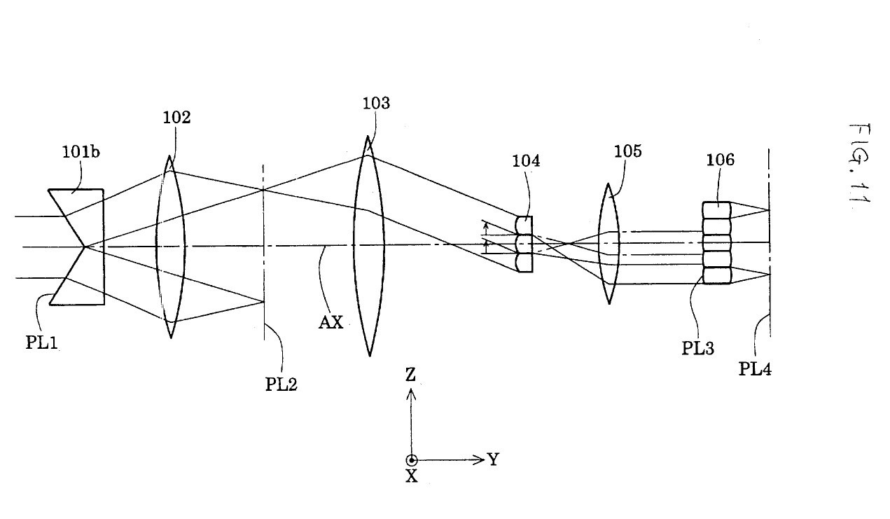

FIG. 12 shows cross sections of light beam at various planes included in the conventional illuminating optical apparatus.

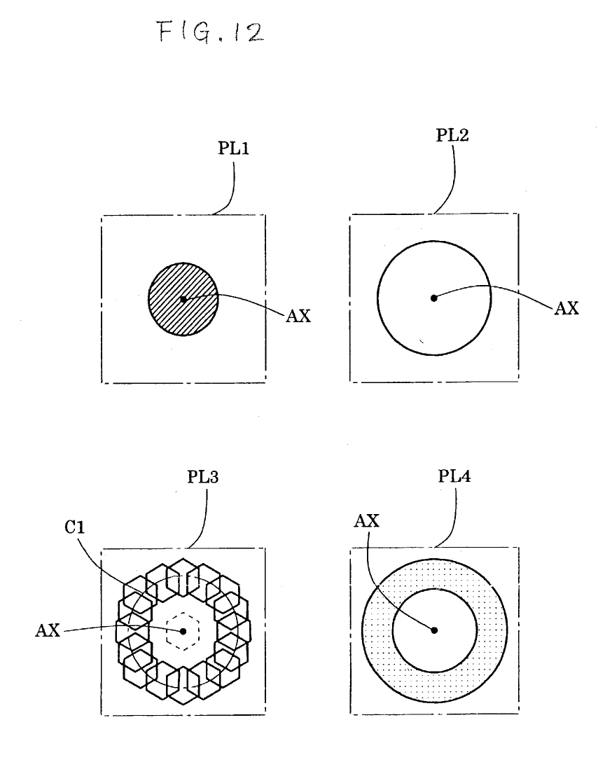

FIG. 13 schematically shows a structure of first fly's eye lens.

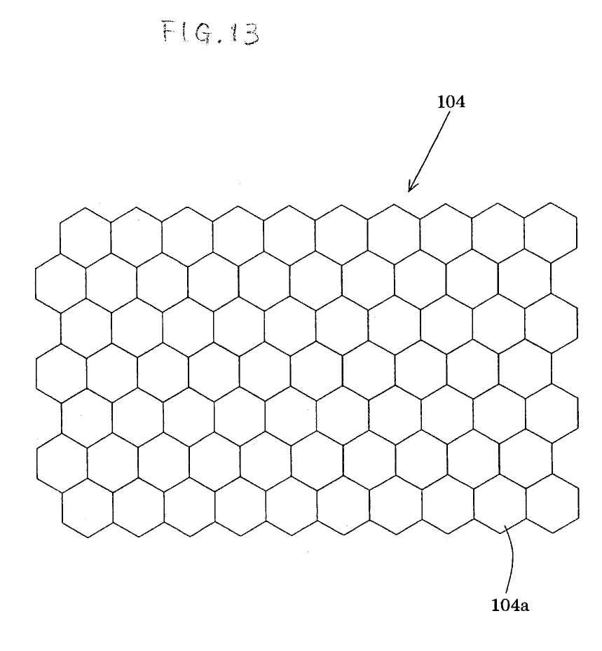

FIG. 14 is a result of simulation with respect to illuminance distribution in a annular illumination field formed on an incident plane of second fly's eye lens

FIG. 15 is explanatory diagram of the cause of non-uniform illuminance distribution of the annular illumination field formed on an incident plane of second fly's eye lens.

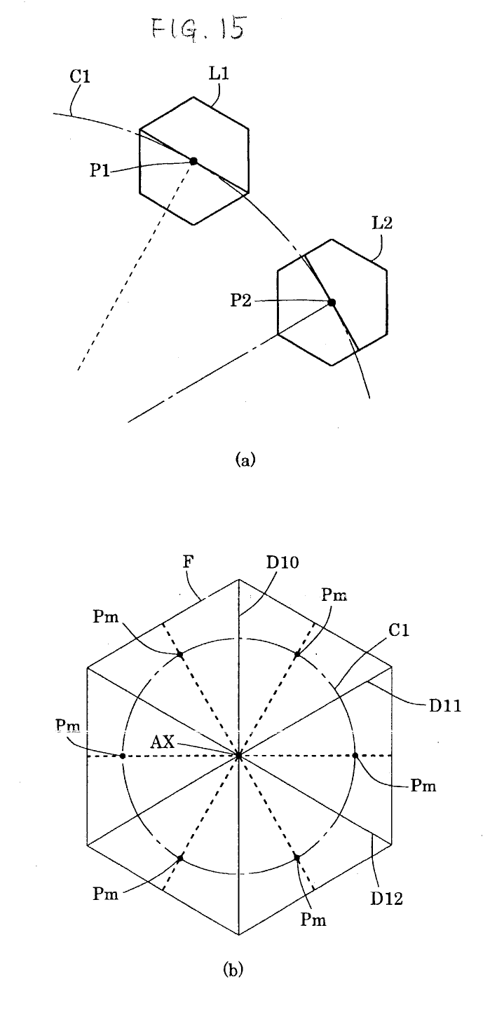

FIG. 16 schematically shows a first modified example with respect to a whole structure of diffractive optical element.

FIG. 17 schematically shows a second modified example with respect to a whole structure of diffractive optical element.

FIG. 18 schematically shows a cross section of central area in a ring-shaped diffraction grating formed on a standard element and three types of complementary elements in the second modified example.

FIG. 19 schematically shows a configuration of a mask used for manufacturing a diffractive optical element by lithography.

FIG. 20 shows a diffractive optical element formed on a glass substrate by using the mask of FIG. 19.

FIG. 21 schematically shows a primary structure of an exposure apparatus of FIG. 1 where a rod integrator is used in place of a micro lens array.

FIG. 22(a) shows a cross section of a blaze-type ring-shaped diffractive optical element taken along the line containing a center A (B) of ring pattern, FIG. 22(b) is a cross section of a multi-step level-type ring-shaped diffractive optical element taken along the line containing a center A (B.) of ring pattern and FIG. 22(c) shows a cross section of a binary-type ring-shaped diffractive optical element taken along the line containing a center A (B) of ring pattern.

FIG. 23 shows a holder for holding a diffractive optical element and a pair of cover glasses fixed thereon to cover the diffractive optical element.

### DESCRIPTION OF THE PREFERRED EMBODIMENTS

In a typical embodiment of the present invention, a diffractive optical element includes a first basic diffraction element where a ring-shaped diffraction grating is formed being eccentric with respect to a center of outer shape in the first direction, and a second basic diffraction element where a ring-shaped diffraction grating is formed being eccentric with respect to a center of outer shape in the second direction. In this case, as described later on, intensity distributions of the first and the second basic diffraction elements are different from each other with respect to a dependency of peak and valley of light intensity distribution on an angle of direction.

In the intensity distribution of the present invention, peak and valley in the light intensity distribution make up for each other to provide flat intensity distribution with less dependency on angle of direction. Therefore, an illuminating optical apparatus having the diffractive optical element of the present invention can form a substantially uniform annular illuminance distribution on both an plane and an illumination pupil plane, which leads to making a good annular illumination with less loss of light beam amount.

An exposure apparatus and an exposure method using illuminating optical apparatus of the present invention are capable of making high-fidelity transfer of a mask pattern onto a photosensitive substrate under the optimal illumination condition for the mask by using an illuminating optical apparatus capable of providing a good annular illumination with less loss of light beam amount. An exposure apparatus and an exposure method of the present invention, which are capable of making high-fidelity transfer of a mask pattern onto a photosensitive substrate, can manufacture good high quality micro-devices.

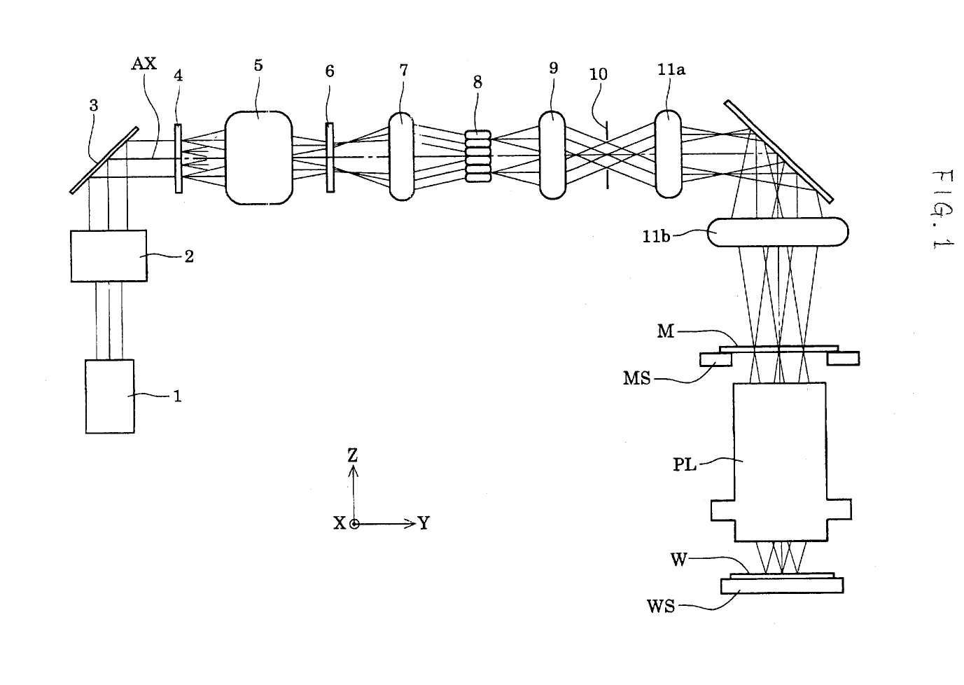

FIG. 1 shows schematic diagram of an exposure apparatus including an illuminating optical apparatus according to an embodiment of the present invention. In FIG. 1, X, Y and Z axes are set as follows. That is, the Z axis extends in the direction of the normal line of a wafer as a photosensitive substrate, the Y axis extends in the direction parallel to the plane of paper of FIG. 1 in the wafer surface, and the X axis extends in the direction perpendicular to the plane of paper of FIG. 1 in the wafer surface.

The exposure apparatus shown in FIG. 1 is provided with an excimer laser light source for supplying the light having a wavelength of 193 nm (Ar F excimer laser) or 248 nm (Kr F excimer laser) as a light source 1 for supplying the exposure light beam (illumination light beam). The substantially parallel light beam, which is radiated from the light source 1 in the Z direction, comes into a beam modifying system 2 which has a rectangular cross section-elongated in the X direction. The beam modifying system 2 includes the negative refractive power lens and the positive refractive power lens in the plane of paper of FIG. 1 (in the YZ plane).

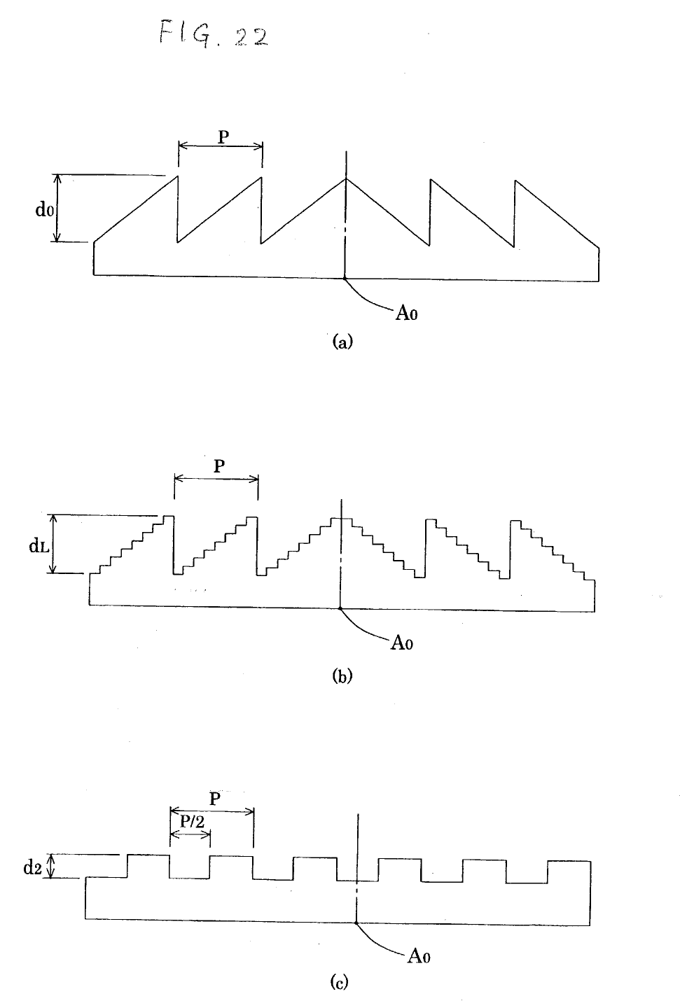

The substantially parallel light beam, which has passes through the beam modifying system 2, is deflected by a bending mirror 3 in the Y direction, and then it comes into a diffractive optical element 4. In general, the diffractive optical element is constructed by forming steps on a glass substrate. Examples of the construction are shown in FIG. 22, where d₀, d_{L} and d₂ represent the height of the steps and P represents the pitch of the steps (distance between adjacent two steps). For example, height of the steps are approximately equal to the wavelength of the exposure light beam (illumination light beam) and pitch of the steps ranges from severalfold to several-dozenfold wavelength of the exposure light beam. The diffractive optical element has a function to diffract the incoming light beam at a desired angle. The diffracting optical element 4 functions as a light beam diverging element which has a function to form a circular light beam in the far field thereof when the parallel light beam having a rectangular cross section comes thereinto.

The light beam diffracted by the diffractive optical element 4 comes into a first variable power optical system (afocal zoom lens) 5 to form a circular light beam on the pupil plane. A light from the circular light beam is radiated from the first variable power optical system 5 to come into a diffractive optical element 6 for annular illumination. The first variable power optical system 5 is constituted so that the magnification can be changed within a predetermined range while keeping approximate conjugate relation between the diffraction element 4 as a light beam diverging element and the diffraction element 6 for an annular illumination. As shown in FIG. 1, the diffractive optical element 6 is slightly shifted toward the light source from the position which makes exact optical conjugate relation with the diffractive optical element 4.

The light beam comes into the diffractive optical element 6 from an oblique direction substantially symmetrically with respect to the optical axis AX. That is the diffractive optical element 4 and the first variable power optical system 5 construct an angled-light-beam forming means capable of converting a light beam from the light source 1 into a light beam with a variety of angle component with respect to the optical axis AX and sending into an incident plane (first predetermined plane). The diffraction optical system 6 has a function to form a ring-shaped light beam with a center of optical axis AX in the far field by diffracting a parallel light beam. Detailed structure and function of the diffractive optical element 6 will be described later on.

The light beam through the diffractive optical element 6 illuminates a micro lens array (or fly's eye lens) 8 as an optical integrator after passing through the second variable power optical system (zoom lens) 7. The second variable power optical system 7 is arranged to keep the diffractive optical element 6 and the rear side focal plane of micro lens array 8 in optically substantial conjugate relation. In other words, the second variable power optical system 7 connects the diffractive optical element 6 and the incident plane of the micro lens array 8 substantially in a relationship of Fourier transform.

Therefore, the light beam after passing through the diffractive optical element 6 forms light intensity distribution, i.e., annular illumination field with a center of optical axis AX on the rear focal plane of the second variable power optical system 7 (and on the incident plane of the micro lens array 8), wherein the light intensity distribution is formed based on convolution of a circular distribution by the diffractive optical element 4 and a ring-shaped distribution by the diffractive optical element 6. Thus the diffractive optical element 6 and the second variable power optical system 7 construct an illumination field forming means for forming an annular illumination field with a center of optical axis AX on an incident plane of the micro lens array 8 (second predetermined plane) based on an incoming light beam with a variety of angle component coming into the incident plane of the diffractive optical element 6 (first predetermined plane) A width of the annular illumination field (a half of difference between the outer diameter and the inner diameter) changes depending on a magnification of the first variable power optical system 5 and the over-all size changes depending on a focal length of the second variable power optical system 7.

The micro lens array 8 is an optical element composed of a large number of micro lenses having the positive refractive power arranged densely in the vertical and lateral directions. Each of the respective lens elements for constructing the micro lens array 8 has a rectangular cross section which is similar to the shape of the illumination field to be formed on the mask (and consequently to the shape of the exposure area to be formed on the wafer). In general, the micro lens array is constructed such that a plane parallel glass plate is subjected to an etching treatment to form a group of minute lenses.

In this arrangement, the respective micro lenses, which constitute the micro lens array, are more minute than the respective lens elements which constitute the fly's eye lens. In the micro lens array, a large number of the micro lenses are formed in an integrated manner without being isolated from each other, unlike the fly's eye lens which is composed of the lens elements isolated from each other. However, the micro lens array is the same as the fly's eye lens in that the lens elements having the positive refractive power are arranged vertically and laterally. In FIG. 1, for the purpose of clarification of the drawing, the micro lenses for constructing the micro lens array are depicted in a number which is extremely smaller than the actual number.

Therefore, the light beam, which comes into the micro lens array 8, is two-dimensionally divided by the large number of micro lenses. Secondary light source having the same light intensity distribution as an illumination field formed by an incoming light beam into the micro lens array, i.e., secondary light source composed of an annular substantial plane light source with a center of optical axis AX is formed on the rear side focal plane of the micro lens array 8. Thus the micro lens array 8 constitutes an optical integrator for forming an annular secondary light source of which light intensity distribution is substantially the same as that of an annular illumination field based on a light beam from an annular illumination field formed on the incident plane (second predetermined plane) of the micro lens array.

The light beam from the annular secondary light source, which is formed on the rear side focal plane of the micro lens array 8, is collected by using the condenser optical system 9 to illuminate a mask blind 10 as an illumination field stop in the superimposed manner after the light beam amount is limited by an aperture stop with annular-shaped light transmitting section if necessary. The light beam, which has passed through the rectangular opening (light-transmitting section) of the mask blind 10 is collected by using an image-forming optical system (11a, 11b) to illuminate a mask M in the superimposed manner. The image-forming optical system (11a, 11b) optically connects the mask blind 10 and the mask M in a substantially conjugate manner. Thus an image of the rectangular opening of the mask blind 10 is formed on the mask M by the aid of the image-forming optical system (11a, 11b)

The mask M is held on a mask stage MS which is two-dimensionally movable. The light beam which passed through a pattern of the mask M forms an image of the mask pattern on a wafer W (photosensitive substrate) by the aid of a projection optical system PL. The wafer W is held on a wafer stage WS which is also two-dimensionally movable. A full field exposure or a scanning exposure is performed while two-dimensionally driving and controlling the wafer W in the plane (XY plane) perpendicular to the optical axis AX of the projection optical system PL. Thus, the respective exposure areas on the wafer W are successively exposed with the pattern on the mask M.

In the full field exposure, each of the exposure areas on the wafer is collectively exposed with the mask pattern in accordance with the so-called step-and-repeat system. In this case, the shape of the illumination area on the mask M is a rectangular configuration which is close to a square. The cross-sectional configuration of each of the lens elements of the micro lens array 8 is also a rectangular configuration which is close to a square. On the other hand, in the scanning exposure, each of the exposure areas on the wafer is subjected to scanning exposure with the mask pattern while relatively moving the mask and the wafer with respect to the projection optical system in accordance with the so-called step-and-scan system. In this case, the shape of the illumination area on the mask M is a rectangular configuration in which the ratio between the short side and the long side is, for example, 1:3. The cross-sectional configuration of each of the lens elements of the micro lens array 8 is also a rectangular configuration which is similar thereto.

In the embodiment, the micro lens array (or fly's eye lens), which is composed of a large number of regular hexagonal micro lenses (or lens elements) having the positive refractive power arranged densely in the vertical and lateral directions, can be used in stead of the diffractive optical element 4 as a light beam diverging element. In this case, on the incident plane of the micro lens array 8 is formed the light intensity distribution based on convolution of a regular hexagonal distribution and a ring-shaped distribution, i.e., an annular illumination field with a center of optical axis AX and on the rear focal plane of the micro lens array 8 is formed secondary light source composed of an annular substantial plane light source with a center of optical axis AX.

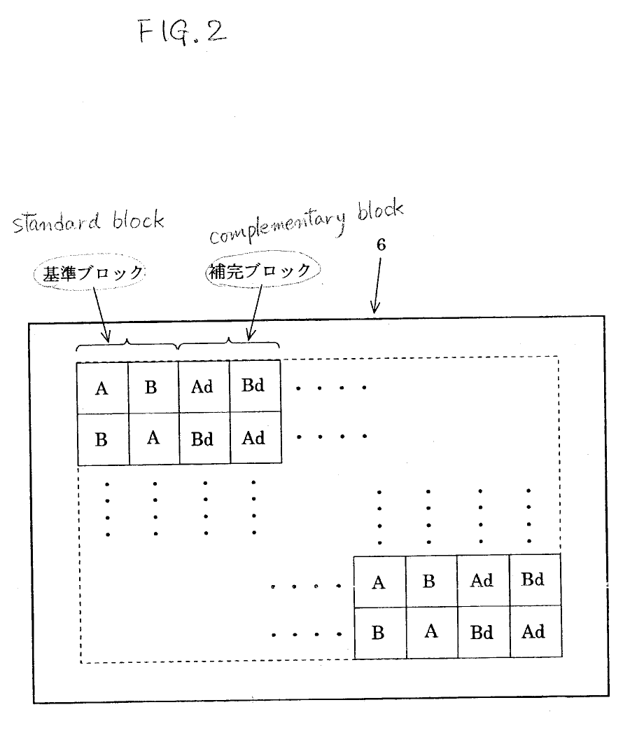

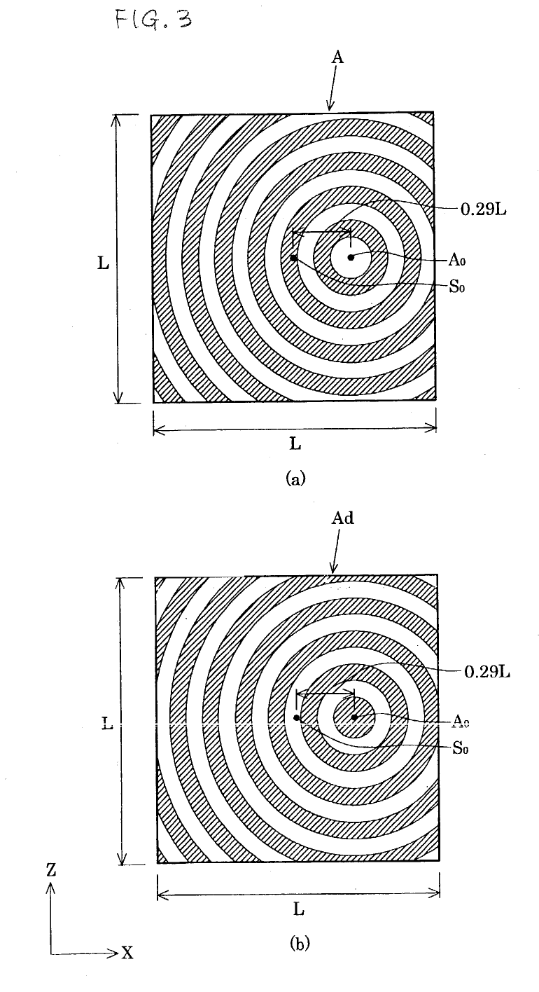

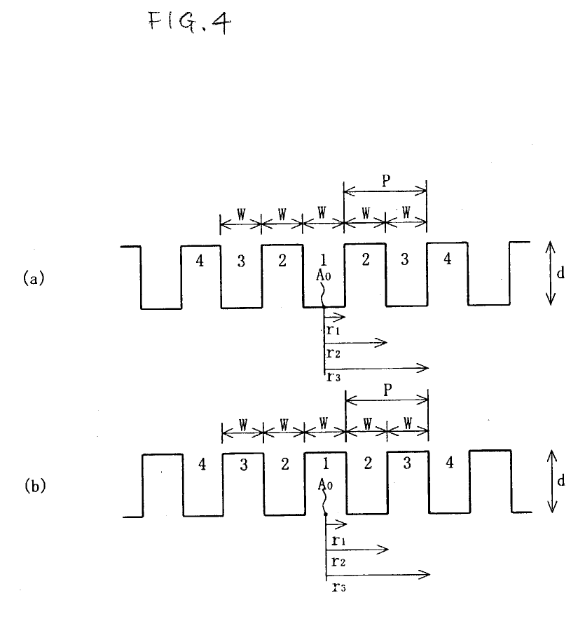

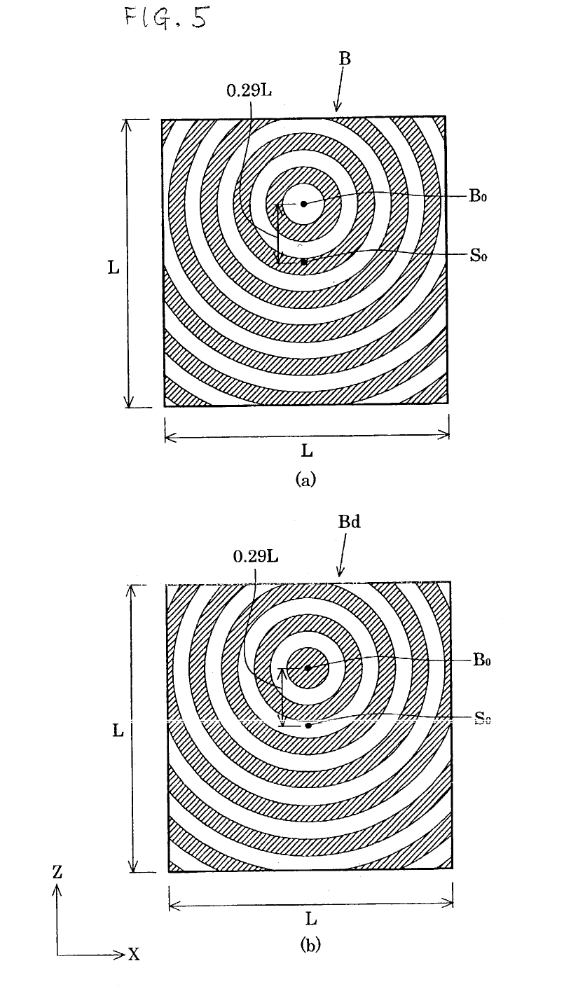

FIG. 2 schematically shows a whole structure of a diffractive optical element used for annular illumination in this embodiment. FIG. 3 schematically shows a structure of a first basic diffraction element included in the diffractive optical element used for the annular illumination of the embodiment. FIG. 4 schematically shows cross sectional views of a first basic diffraction element and a second basic diffraction element included in a diffractive optical element used for annular illumination in this embodiment. FIG. 5 schematically shows a structure of a second basic diffraction element included in the diffractive optical element used for the annular illumination of this embodiment.

In FIG. 2, the diffractive optical element 6 of this embodiment used for the annular illumination is composed of a large number of the first basic diffraction element (A, Ad) and the second basic diffraction element (B, Bd) arranged densely in the vertical and lateral directions. As shown in FIG. 3, the first basic diffraction element (A, Ad) has a square shape contour of which a side is L in length and equally spaced ring-shaped phase diffraction grating is formed at A₀ point as a center which is eccentric Δ (eccentricity=0.29 L) in the +X direction with respect to the center of the contour S₀.

FIG. 4(a) and FIG. 4(b) show cross sectional view of the first basic diffraction element A and Ad taken on the line containing the point A₀. In FIG. 4(a), an element A which is one of the first basic diffraction element A and Ad is composed of circular region 1 with a center A₀ which is rᵢ in radius and annular region i (i=2, 3 . . . ) which is the region between radius rᵢ circle line and radius rᵢ₋₁ circle line. The diameter of the circular region 1 is W and width of the annular region i, that is, rᵢ−rᵢ₋₁ is W constantly. Namely the element A is a one-dimensional phase diffraction element, which is d in depth, P (=2W) in pitch and W in all line width in the cross section taken along the line passing through the point A₀. The annular region i is a projecting area (hatched portion in FIG. 3(a)), if i=even number. Namely, even-numbered regions are projection areas assuming that a center is in odd-numbered region 1. In this sense, a first basic diffractive element A is called a first standard element A. FIG. 4(b) shows cross sectional view of the other first basic diffractive element Ad. In the diffractive element Ad, the annular region i is a projecting area (hatched portion in FIG. 3(b)), if i=odd number. Namely, odd-numbered regions are projection areas assuming that a center is in odd-numbered region 1. In the element A, a region i is a recessed area if i=odd number. In this sense, a first basic diffractive element Ad is called a first complementary element Ad.

In FIG. 5, a second basic diffractive element (B, Bd) seems to have similar structure to the first basic diffractive element (A, Ad). In the first basic diffractive element (A, Ad), point A₀ which is the center of the equally spaced ring-shaped phase diffraction grating is eccentric eccentricity Δ=0.29 L in the +X direction with respect to the center of the contour S₀. In the second basic diffractive element (B, Bd), however, point B₀ which is the center of the equally spaced ring-shaped phase diffraction grating is eccentric eccentricity Δ=0.29 L in the +Z direction with respect to the center of the contour S₀.

The second basic diffractive element is composed of a second standard element B and a second complementary element Bd. In the second standard element B, the annular region i is a projecting area (hatched portion in FIG. 5(a)), if i=even number. In the second complementary element Bd, the annular region i is a projecting area (hatched portion in FIG. 5(b)), if i=odd number.

In an example of this embodiment, one side L, of each square shape element A, Ad, B, Bd, is 250 μm; pitch P, of the ring-shaped phase diffraction grating shown in FIG. 4 and FIG. 5, is 3 μm. Eccentricity Δ=0.29L=72.5 μm. Step height d in the ring-shaped phase diffraction grating (difference between projected part and recessed part) is determined by the following expression (1) so that phase difference becomes λ/2.

d=λ/[2(n1−n2)] (1)

Here, λ is wave length of illumination light beam (exposure light), i.e., wave length in use n1 is refractive index of glass substrate of the diffractive optical element 6 with respect to wave length in use and n2 is refractive index of medium forming atmosphere of illumination optical path with respect to wave length in use. If wave length λ is 193 nm, refractive index of glass substrate is 1.5 and that of air or inert gas as medium is 1.0, the step height d of the ring-shaped phase diffraction grating should be 193 nm.

In FIG. 2, the diffractive optical element 6 of this embodiment includes same number of the first standard element A, the first complementary element Ad, the second standard element B and the second complementary element Bd. Also it can be said that the diffractive optical element 6 includes same number of standard block and complementary block, wherein the standard block is composed of two sets of first standard element A and second standard element B (total four standard elements) and the complementary block is composed of two sets of first complementary element Ad and second complementary element Bd (total four complementary elements). Spatial positioning and arrangement of the standard blocks and the complementary blocks is determined based on random number generation by computer. That is, generating some of random number sequences of 0 and 1, selecting the random number sequence having the same number of 0 and 1 then allocating a standard block to 0 and a complementary block to 1. The numbers of standard blocks and complementary blocks need not to be exactly the same, several % variance can be tolerated.

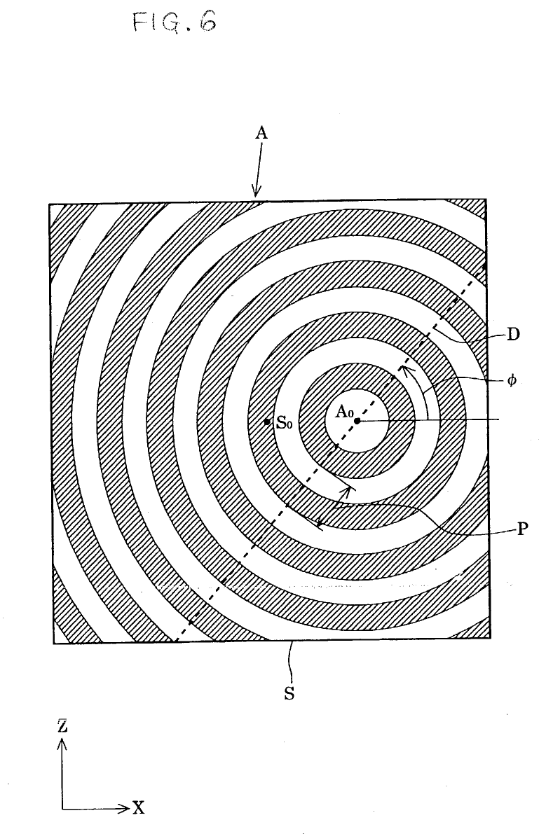

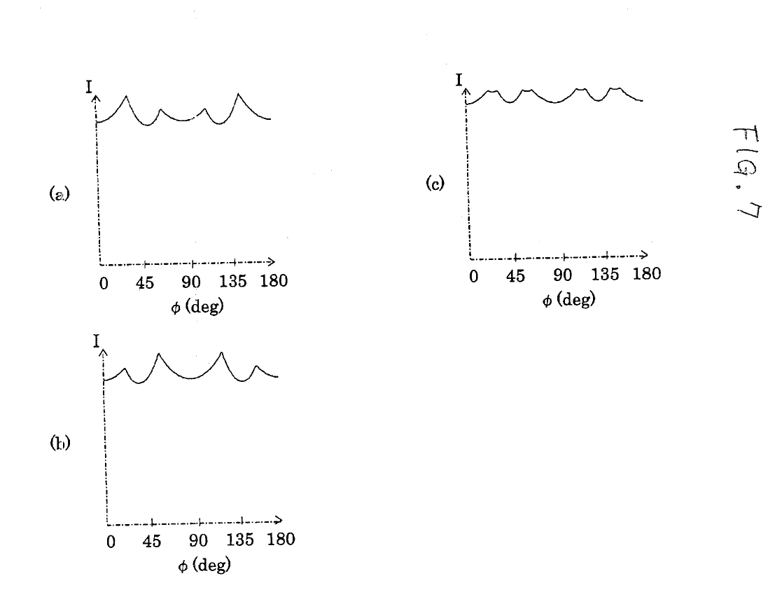

FIG. 6 is a first explanatory diagram of intensity distribution characteristics of a diffractive optical element for annular illumination in this embodiment. FIG. 7 is a second explanatory diagram of intensity distribution characteristics of a diffractive optical element for annular illumination in this embodiment. As described above, each of elements A, Ad, B and Bd has an equally spaced ring-shaped phase diffraction grating. If the size of each element is infinitely large, same intensity light beam is radiated in all direction of a cone defined by divergent angle θ=sin⁻¹(λ/P)

In practice, however, each element has a square outer shape (contour) of limited size especially because a diffractive optical element is composed of a large number of elements are arranged densely in the vertical and lateral directions (integrated). Therefore the intensity distribution comes into existence with respect to angle of direction. (See FIG. 6) In this embodiment, the intensity distribution with respect to angle of direction is optimized (uniformized) by making centers A 0 and B 0 of a ring-shaped phase diffraction grating being eccentric away from a center S 0 of square outer shape (contour).

FIG. 6 shows a straight broken line segment D, which passes a center A₀ of the ring-shaped phase diffraction grating. Formed on the first standard element and cut off at the both end by square border S. Angle between the broken line D and X axis is defined as angle of direction. The broken line segment D is an additional line to estimate a diffracted light intensity with respect to a certain angle of direction., i.e., length of the broken line segment D represents intensity weight of diffracted light diverging in the direction of angle.,

In FIG. 7, (a) shows an intensity distribution characteristics (characteristics) of a first basic diffractive element (A, Ad), (b) shows an intensity distribution characteristics of a second basic diffractive element (B, Bd) and (c) shows an intensity distribution characteristics of a whole diffractive optical element 6 for annular illumination. In FIGS. 7(a) (b) (c), horizontal axis represents angle of direction (degree) and vertical axis I represents light intensity in the direction.

According to FIG. 7(a) and FIG. 6, in the intensity distribution characteristics of a first basic diffractive element (A, Ad), the light intensity I increases as angle of direction increases from 0 degree and reaches maximum value Iₘₐₓ when the broken line D reaches a first apex of the square border S (bottom left apex of FIG. 6). Then the light intensity I decreases to reach minimum value Iₘᵢₙ then turns to increase as the angle continues to increase. When the broken line D reaches a second apex of the square border S (top right apex of FIG. 6), the light intensity I reaches local maximum value I₁ (I₁<Iₘₐₓ). Then the light intensity start to decrease and becomes local minimum value I₂ (I₂>Iₘᵢₙ) when the angle becomes 90 degree.

As the angle of direction reaches more than 90 degree, the light intensity in the direction increases again and reaches local maximum value I₁ when the broken line D reaches a third apex of the square border S (bottom right apex of FIG. 6). As the angle increases more, the light intensity I decreases to reach the minimum Iₘᵢₙ then turn into increase to become maximum value Iₘₐₓ when the broken line D reaches a fourth apex of the square border S (top left apex of FIG. 6). After that, the light intensity I start to decrease and reaches local minimum value I₂ when the angle of direction reaches 180 degree.

As described above, the change of light intensity I caused during 0-90 degree change of angle of direction is equal to that caused during 180-90 degree change of angle. Change of light intensity I while angle is between 180 degree and 360 degree is the same as change while the angle changes from 0 degree to 180 degree, which is, although, not shown.

According to FIG. 7(b) and FIG. 5, in the intensity distribution characteristics of a second basic diffractive element (B, Bd), the light intensity I increases as angle of direction increases from 0 degree and reaches local maximum value I₁ when the broken line D reaches a first apex of the square border S (top right apex of FIG. 5). Then the light intensity I decreases to reach minimum value Iₘᵢₙ then turns to increase as the angle continues to increase. When the broken line D reaches a second apex of the square border S (bottom left apex of FIG. 5), the light intensity I reaches maximum value Iₘᵢₙ. Then the light intensity starts to decrease and becomes local minimum I₂ when the angle becomes 90 degree.

As the angle of direction reaches more than 90 degree, the light intensity in the direction increases again and reaches Iₘₐₓ maximum value when the broken line D reaches a third apex of the square border S (bottom right apex of FIG. 5). As the angle increases more, the light intensity I decreases to reach the minimum value Iₘᵢₙ then turn into increase to become local maximum value I₁ when the broken line D reaches a fourth apex of the square border S (top left apex of FIG. 5). After that, the light intensity I starts decreasing and reaches local minimum value I₂ when the angle of direction reaches 180 degree.

As described above, in the intensity distribution characteristics of the second basic diffractive element (B, Bd), the change of light intensity I caused during 0-90 degree change of angle of direction is equal to that caused during 180-90 degree change of angle. Change of light intensity I while angle is between 180 degree and 360 degree is the same as change while the angle changes from 0 degree to 180 degree, which is, although, not shown. As a whole, the intensity distribution characteristics of the second basic diffractive element (B, Bd) is shifted from that of the first basic diffractive element (A, Ad) by 90 degree with respect to the angle of direction.

As described above, the diffractive optical element for annular illumination includes the same number of the first basic diffractive elements (A, Ad) and the second basic diffractive elements (B, Bd). Therefore, the intensity distribution characteristics shows an average of the intensity distribution characteristics of the first basic element (A, Ad) and that of the second basic element (B, Bd) as shown in FIG. 7(c).

In the intensity distribution characteristics of the first basic diffractive elements (A, Ad) and the second basic diffractive elements (B, Bd), peak (maximum or local maximum) and valley (minimum or local minimum) in the distribution of light intensity I depends on the angle of direction in different way. Thus, in the intensity distribution characteristics of the diffractive optical element 6, the peak and the valley function to make up for each other, which leads to weakening dependency of intensity distribution on the angle., i.e., flatter intensity distribution.

It is possible to estimate the uniformity of the intensity distribution characteristics of the diffractive optical element 6, in other words, dependency of the intensity distribution on the angle., by using “intensity uniformity contrast C” represented by the following equation (2).

C=(Iₘₐₓ−Iₘᵢₙ)/(Iₘₐₓ+Iₘᵢₙ) (2)

Intensity uniformity contrast C in the intensity distribution characteristics of the diffractive optical element 6 is about 4%. In the conventional diffractive element, where a center of ring-shaped phase diffraction grating is not eccentric with respect to a center of the square border, intensity uniformity contrast C is about 17%. In both the first basic diffractive element (A, Ad) and the second basic diffractive element (B, Bd) where a center of ring-shaped phase diffraction grating is eccentric with respect to a center of the square border, intensity uniformity contrast C is about 7%.

As explained above, the diffractive optical element 6 of this embodiment used for the annular illumination is composed of the first basic diffractive element (A, Ad) and the second basic diffractive element (B, Bd), where the first basic diffractive element (A, Ad) has a square shape contour and ring-shaped phase diffraction grating formed at A 0 point as a center which is eccentric in the +X direction with respect to the center of the contour S 0 and the second basic diffractive element (B, Bd) has a square shape contour and ring-shaped phase diffraction grating formed at B₀ point as a center which is eccentric in the +Z direction with respect to the center of the contour S₀. In the intensity distribution characteristics of the first basic diffractive elements (A, Ad) and the second basic diffractive elements (B, Bd), peak and valley in the distribution of light intensity I depends on the angle of direction in different way in the two elements.

Therefore, in the intensity distribution characteristics of the diffractive optical element 6, the peak and the valley function to make up for each other in the light intensity distribution, which leads to reducing dependency of intensity distribution on the angle and results in obtaining flatter intensity distribution. Consequently, an illuminating optical apparatus of the present embodiment can form a substantially uniform annular illuminance distribution on both an illumination plane and an illumination pupil plane, which leads to making a good annular illumination with less loss of light beam amount.

In this embodiment, in particular, an eccentric direction in the first diffractive element (A, Ad) is perpendicular to that of the second diffractive element (B, Bd). Therefore the intensity distribution characteristics of the first basic diffractive element (A, Ad) and that of the second basic diffractive element (B, Bd) are shifted by 90 degree from each other. As a result, the ring-shaped illuminance distribution on both an illumination plane and an illumination pupil plane become four-times-rotation-symmetric with respect to an optical axis AX.

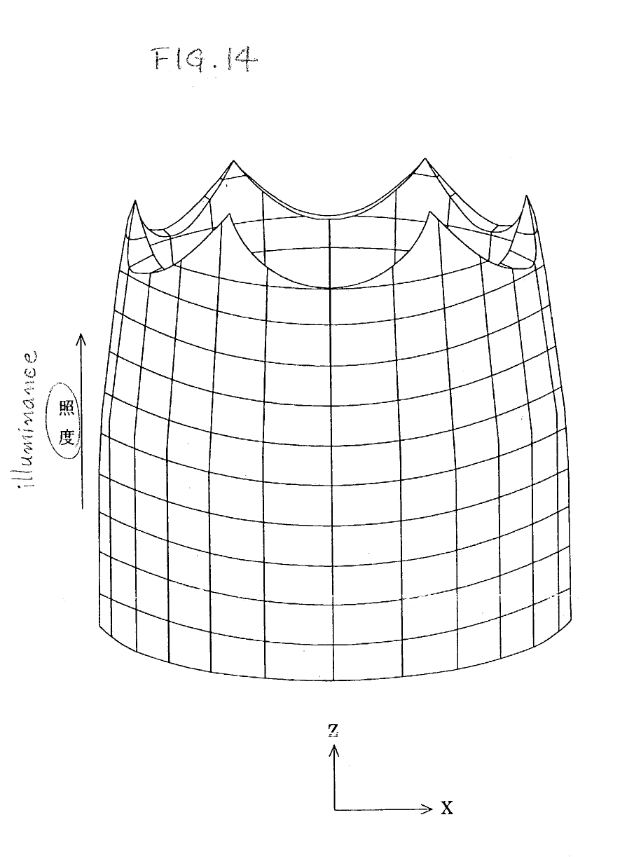

In aforementioned conventional technique, the ring-shaped illuminance distribution on both an illumination plane and an illumination pupil plane becomes six-times-rotation-symmetric with respect to an optical axis AX as shown in FIG. 14. Therefore, illumination condition becomes different in the orthogonal two directions on a mask or a wafer of the illumination plane, which causes line width of a pattern to be transferred onto the wafer to become different in the orthogonal two directions (two directions perpendicular to each other). Contrary in this embodiment, the ring-shaped illuminance distribution on both an illumination plane and an illumination pupil plane becomes four-times-rotation-symmetric with respect to the optical axis, if not perfectly uniform, which can reduce the difference of line width in the orthogonal two directions, so-called VH line width difference.

In this embodiment, eccentricities of the first basic diffractive element (A, Ad) and the second basic diffractive element (B, Bd) is the same and the number of the first one (A, Ad) and the second one (B, Bd) is also the same. As a result, it becomes possible to make peaks and valleys of light intensity I distribution with respect to intensity distribution characteristics of the diffractive optical element 6 flatter in most effective way. This leads to minimization of intensity uniformity contrast C and optimization of uniformity in annular illuminance distribution.

Furthermore, the first basic diffractive element (A, Ad) is composed of the first standard element A and the first complementary element Ad each of which has mutually complementary ring-shaped phase diffraction grating and the second basic diffractive element (B, Bd) is composed of the second standard element B and the second complementary element Bd each of which has mutually complementary ring-shaped phase diffraction grating, and yet substantially the same number of the standard blocks and the complementary blocks are arranged spatially in a random order. This structure is capable of restraining an affect from interference fringes in the annular illuminance distribution.

In this embodiment, ArF excimer laser light is used. Therefore the rectangular cross section light beam coming into the diffractive optical element 6 has a Gaussian type light intensity distribution along one side and a top-hat type light intensity distribution along the other side. The structure of this embodiment, having a pair of first standard element A and second standard element B and a pair of first complementary element Ad and second standard element Bd which are alternately adjacently arrayed, is capable of forming relatively uniform illuminance distribution on both an illumination plane and an illumination pupil plane, even if there is such a light intensity distribution of incoming light bean to the diffractive optical element 6.

In the embodiment described above, both of the first basic diffractive element (A, Ad) and the second basic diffractive element (B, Bd) has a square outer shape (contour). However, other contours including a regular hexagon can be used for each of elements A, Ad, B and Bd. Also a refractive optical element can be used in stead of the diffractive optical element 6 for forming an annular illuminance distribution. In the embodiment explained above, two types of eccentricity (in a set of direction and eccentricity amount) is exemplified. Three or more types of eccentricity can be applied. When n^{th} (number) types of eccentricity is used, embodiment should be modified so that peaks and valleys of each basic diffractive element (from first element through nth element) can make up for each other and yet an annular intensity distribution has 4(or a multiple of 4)-times-rotation-symmetry with respect to the optical axis AX. In this modification, it is preferable that the same number of n types basic diffractive elements is included and each elements are arranged spatially in a random order

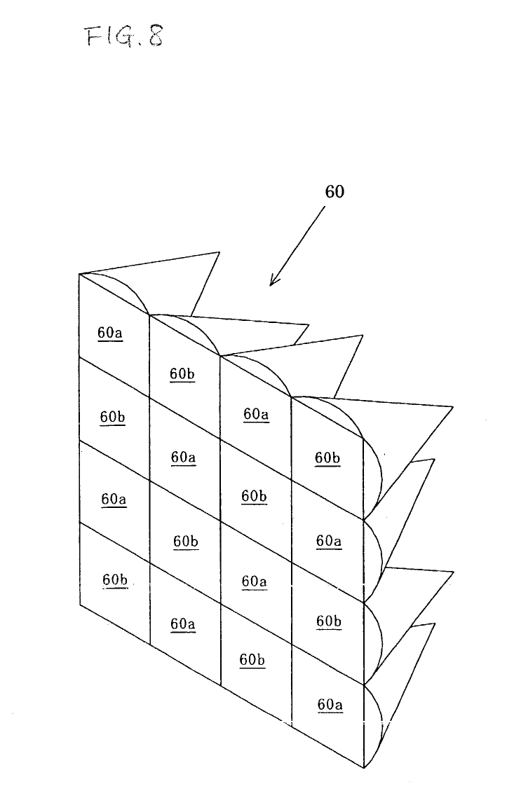

FIG. 8 schematically shows a whole structure of a usable refractive optical element in substitution for a diffractive optical element used for annular illumination in this embodiment. The refractive optical element 60 is composed of a large number of a first basic refractive elements 60a and second basic refractive elements 60b, each of elements has a conical prism with the same apex angle. In the first basic refractive element 60a, a center axis of the conical prism (a cone axis which contains a cone point and is perpendicular to the bottom surface of the conical prism) is eccentric in first direction (by parallel displacement) with respect to a center of the square outer shape (contour) and in the second basic refractive element 60b, a center axis of the conical prism is eccentric in second direction (by parallel displacement) with respect to a center of the square outer shape (contour).

Each of the element 60a and the element 60b has the square contour bottom which is made by cutting the prism with the 4 planes parallel to the center axis of the prism so that the prisms can be arranged densely in the vertical and lateral directions. In this modified case shown in FIG. 8, it is preferable that the direction of eccentricity of the first basic refractive element and that of the second one are perpendicular to each other, and eccentricity amounts of both elements 60a and 60b are substantially the same.

It is also preferable that the number of the first refractive optical element 60a and that of the second refractive optical element 60b are the same, and those two types of elements are alternately adjacently. The contours of the bottom shape of the conical prism in both first refractive optical element 60a and second refractive optical element 60b are not limited to a square one but another appropriate shape including a regular hexagon can be applied.

In FIG. 2, the diffractive optical element 6 of this embodiment includes same number of the standard block (A, B, B, A) composed of four standard elements and the complementary block (Ad, Bd, Bd, Ad) composed of four standard elements, and the spatial positioning and arrangement of the standard blocks and the complementary blocks is determined based on random number generation by computer. However the diffractive optical element 6 is not limited to the above of FIG. 2 but can be modified in various ways.

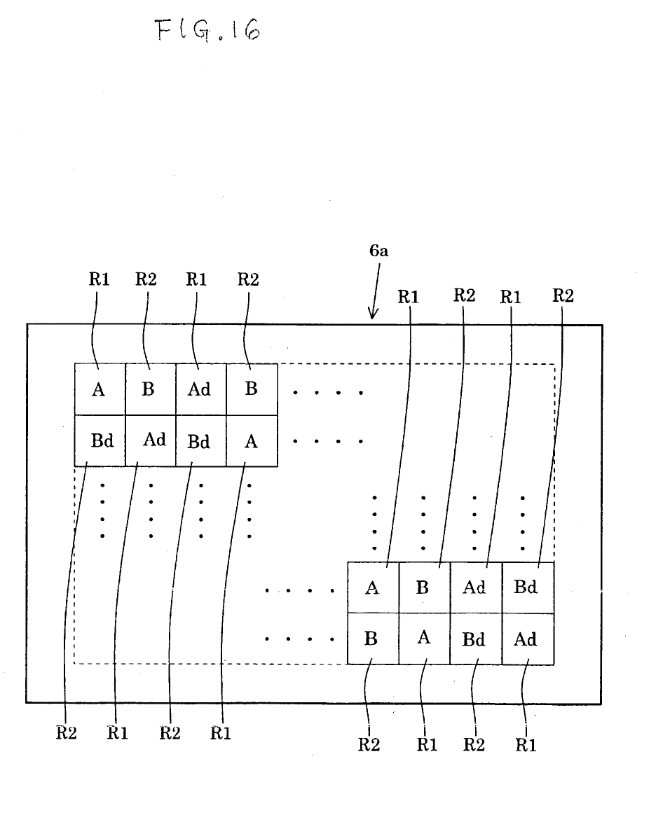

FIG. 16 schematically shows a first modified example with respect to a whole structure of diffractive optical element. In the first modified diffractive optical element 6a, a first region R1 where the first standard element A or the first complementary element Ad is to be disposed, and a second region R2, where the second standard element B or the second complementary element Bd is to be disposed, are arranged in a checkerboard pattern, that is the two regions are arrayed alternately adjacently in the orthogonal two directions. Allocations of the first standard element A and the first complementary element Ad to a large number of the first regions R1 and allocations of the second standard element B and the second complementary element Bd to a large number of the second regions R2 are determined based on random number generation by computer.

Namely, the allocation process with respect to region R1 is as follows; generating some of random number sequences of 0 and 1, selecting the random number sequence where the number of 0 and the number of 1 are substantially the same, then allocating a first standard element A to 0 and a first complementary element Ad to 1. In the same way, allocating a second standard element B to 0 and a second complementary element Bd to 1 is made with respect to region R2.

In the first modified example above the numbers of the first standard element A and the second complementary element Ad included in the diffractive optical element 6a are substantially equal and the numbers of the second standard element B and the second complementary element Bd included in the diffractive optical element 6a are also substantially equal. And also the numbers of the first region R1 and the second region R2 are equal. Consequently the numbers of the first standard element A, the first complementary element Ad, the second standard element B and the second complementary element Bd are substantially equal in the modified diffractive optical element 6a. Thus the first modified example of diffractive optical element in FIG. 16 has higher randomness than that of diffractive element shown in FIG. 2 of which randomness is defined by block unit, which leads to better reduction of an affect from the interference fringes in the annular illuminance distribution.

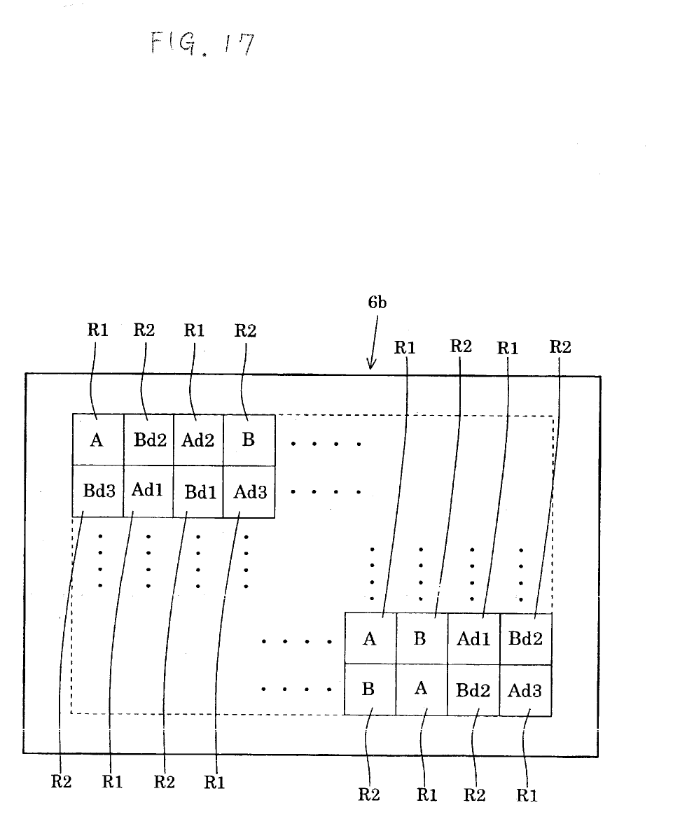

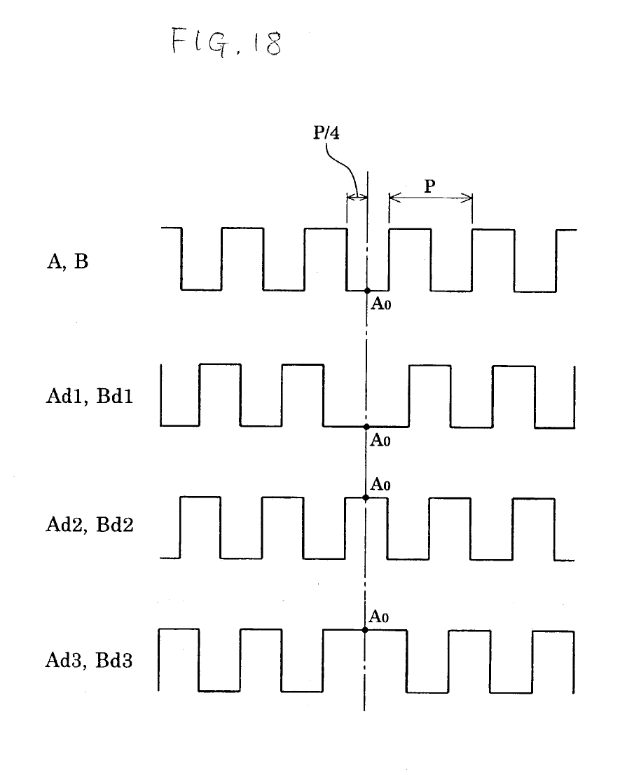

FIG. 17 schematically shows a second modified example with respect to a whole structure of diffractive optical element. FIG. 18 schematically shows a cross section of central area in a ring-shaped diffraction grating formed on a standard element and three types of complementary elements in the second modified example. In the aforementioned embodiment, a phase of light beam radiated from the complementary element (Ad, Bd) is to be π when a phase of light beam radiated from the standard element (A, B) is 0 (zero). In other words, the complementary element (Ad, Bd) is designed to radiate a light field (which is expressed by optical complex amplitude in optics) with having phase difference π with respect to a light field radiated from the standard element (A,B).

In the second modified example, when a phase of light beam radiated from the standard element (A, B) is 0 (zero), a phase of light beam radiated from the complementary element of first phase (Ad1, Bd1) is to be π/2, a phase of light beam radiated from the complementary element of second phase (Ad2, Bd2) is to be IT and a phase of light beam radiated from the complementary element of third phase (Ad3, Bd3) is to be 3π/2. That is, in the second modified example, a first complementary element Ad2 of the second phase has the same pattern as the first complementary element Ad in the aforementioned embodiment and a second complementary element Bd2 of the second phase has the same pattern as the second complementary element Bd in the aforementioned embodiment

Referring to FIG. 18 showing a cross section of the second modified example taken along the line containing a ring pattern center A₀ (B₀), the complementary element of second phase (Ad2, Bd2) having phase difference π is formed based on the ring pattern which is the pattern made by reversing the protrusion/recess pattern of the standard element (A, B) with respect to a cross section containing the ring center A₀ (B₀). The complementary element of first phase (Ad1, Bd1) having phase difference π/2 is formed based on the ring pattern which is the pattern made by shifting the ring pattern of the standard element (A, B) by one fourth of pitch P of the protrusion/recess pattern outwards from the center with respect to a cross section containing the ring center A₀ (B₀). The complementary element of third phase (Ad3, Bd3) is formed based on the ring pattern which is the pattern made by shifting the ring pattern of the standard element (A, B) by one fourth of pitch P of the protrusion/recess pattern towards the center with respect to a cross section containing the ring center A₀ (B₀). In other words, the pattern of the complementary element of first phase (Ad1, Bd1) is the same as reversed pattern of the complementary element of third phase (Ad3, Bd3).

In the second modified example, each of light beams radiated from the standard element (A, B), the complementary element of first phase (Ad1, Bd1), the complementary element of second phase (Ad2, Bd2) and the complementary element of third phase (Ad3, Bd3) are the same in intensity distributions (divergence direction and intensity of light) but the light field defining the intensity distribution is different only in phase. It becomes possible to reduce periodical interference noise considerably by randomly mixing the four types of light beams which are the same in intensity distribution and different in phase.

As shown in FIG. 17, in the diffractive optical element 6b of the second modified example, a first region R1 and a second region R2 are arranged in a checkerboard pattern, that is the two regions are arrayed alternately adjacently in the orthogonal two directions, where in the first region R1 are to be disposed the first standard element A, the first complementary element of first phase Ad1, the first complementary element of second phase Ad2 and the first complementary element of third phase Ad3 and in the second region R2 are to be disposed the second standard element B, the second complementary element of first phase Bd1, the second complementary element of second phase Bd2 and the second complementary element of third phase Bd3. Allocations of the first elements (A, Ad1, Ad2, Ad3) to a large number of the first regions R1 and allocations of the second elements (B, Bd1, Bd2, Bd3) to a large number of the second regions R2 are determined based on random number generation by computer.

More precisely, the allocation process with respect to region R1 is as follows: generating some of random number sequences including 0, 1, 2 and 3; selecting the random number sequence where the numbers of 0, 1, 2, 3 are substantially the same; then allocating a first standard element A to 0, a first complementary element of first phase Ad1 to 1, a first complementary element of second phase Ad2 to 2 and a first complementary element of third phase Ad3 to 3. In the same way with respect to region R2, after selecting the random number sequence, allocating a second standard element B to 0, a second complementary element of first phase Bd1 to 1, a second complementary element of second phase Bd2 to 2 and a second complementary element of third phase Bd3 to 3 is made.

In this second first modified example, the numbers of the first standard element A, a first complementary element of first phase Ad1, a first complementary element of second phase Ad2 and a first complementary element of third phase Ad3 included in the diffractive optical element 6b are substantially the same and the numbers of a second standard element B, a second complementary element of first phase Bd1, a second complementary element of second phase Bd2 and a second complementary element of third phase Bd3 included in the diffractive optical element 6b are also substantially the same. The number of the first region R1 is equal to that of the second region R2. Consequently the numbers of each element A, Ad1, Ad2 and Ad3 included in the diffractive optical element 6b is substantially equal to the number of each element B, Bd1, Bd2 and Bd3 in the same element 6b.

Thus the second modified example of diffractive optical element as well as the first modified example has a specific allocation giving higher randomness than that of diffractive element shown in FIG. 2 of which randomness is defined by block unit, which leads to better reduction of an affect from the interference fringes in the annular illuminance distribution. It becomes possible to reduce periodical interference noise considerably by randomly mixing the four types (two types in the aforementioned embodiment and the first modified example) of light beams which are the same in intensity distribution and different in phase.

In this second modified example, four elements including four types of phase are randomly allocated. It is also possible to increase a type of phase (increasing the number of types of complementary element) to perform more uniform illumination. In general, in the case of providing a standard element with a number of complementary elements having different phases, phase difference between the elements should change with substantially the same phase interval to improve noise reduction function for interference noise.

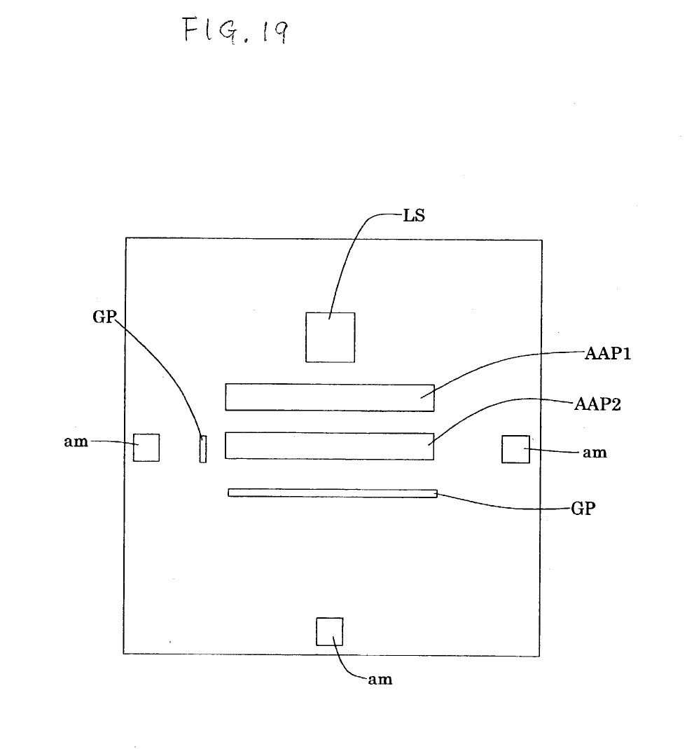

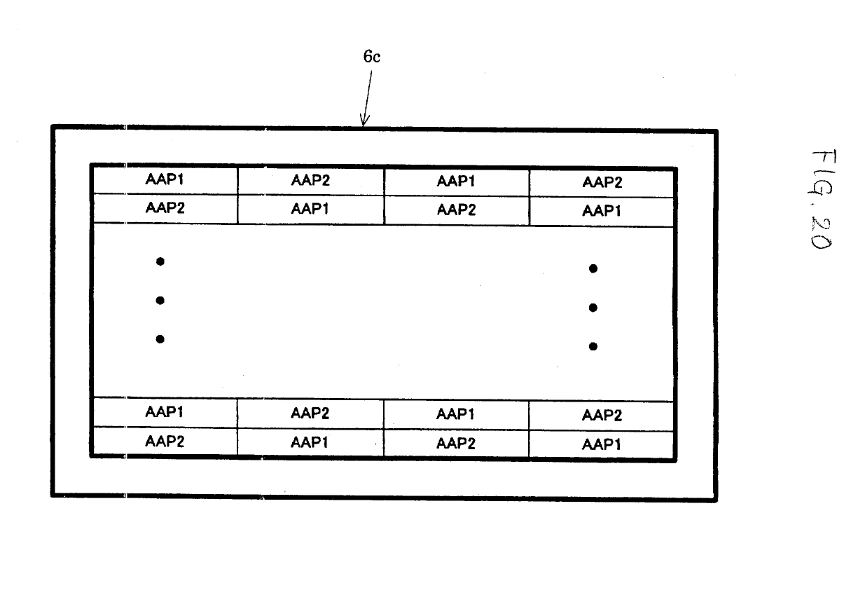

FIG. 19 schematically shows a configuration of a mask used for manufacturing a diffractive optical element by lithography. FIG. 20 shows a diffractive optical element formed on a glass substrate by using the mask of FIG. 19. In FIG. 19, two block patterns MP1 and MP2 are formed by, for example, EB (electron beam) drawing.

In the block pattern MP1, for example, 250 standard blocks (A, B, B, A) and 250 complementary blocks (Ad, Bd, Bd, Ad) are randomly arranged over the whole block pattern. Rule of random arrangement is determined based on random number generation by computer. Likewise in the block pattern MP2, for example, 250 standard blocks (A, B, B, A) and 250 complementary blocks (Ad, Bd, Bd, Ad) are randomly arranged. Rule of random arrangement in the block pattern AAP2 is different from that in the block pattern AAP1.

Along the periphery of the mask, three alignment mark am is drawn. The alignment mark “am” is used as a position reference when the photoresist-coated glass substrate is exposed with the block patterns AAP1 and AAP2 on the mask by using a reduced projection exposure. A pair of cutting guide pattern (guide window) GP is drawn on the mask, which indicates cut-off line to cut out a diffractive optical element in a predetermined shape.

Line and space pattern LS is also formed on the mask which is the pattern for controlling line width and etching depth. The pattern LS contains linear line and space pattern of which line width is about 10 μm therein. Before and after exposure with the block pattern MP1 and AAP2, outside the effective diameter of diffractive optical element is exposed with the pattern LS to control line width and etching depth.

FIG. 20 shows a diffractive optical element 6c which is manufactured by developing and etching after 4×12 times' exposing alternately with block pattern MP1 and MP2 of the mask in FIG. 19. In the diffractive optical element 6c made by that process, elements are not randomly arranged all over the effective diameter (effective area) but partially randomly arranged. In such partially random arrangement, intended optical function is still performed because elements are randomly arranged in each of block patterns which are arranged alternately and coherency of excimer laser is finite. The diffractive optical element can be manufactured with low cost by using one or a small number of photoreticle original plate (mask).

It is preferable to prepare other block patterns, for example, MP3, MP4 which have a different inside arrangement in addition to the two block patterns AAP1 and AAP2 in order to obtain much higher noise-reduction effect with respect to an interference noise. In this case, the diffractive optical element is successively exposed with all the block patterns, developed and etched to be able to form a diffractive optical element of which effective diameter contains partially randomly arranged elements all over the effective diameter (effective area).

In the case that there are too many block patterns to allocate on the same mask of FIG. 19, the rest of block patterns are drawn on other mask(s) separately. A glass substrate can be exposed with a plurality of masks one after another to form a diffractive optical element. Above explained patterning process based on FIG. 19 and FIG. 20 can be applied for manufacturing foregoing first modified example and second modified example.

In the embodiment, modified examples above, a cycle (pitch) of cross section in radial direction of the ring-shaped diffraction grating can be between 0.1 μm and 250 μm, an effective diameter (effective area) of the standard element and the complementary element can be between 5 μm×5 μm and 1000 μm×1000 μm, and the number of the standard element and complementary element in the effective diameter of the diffractive optical element can be more than 10 elements.

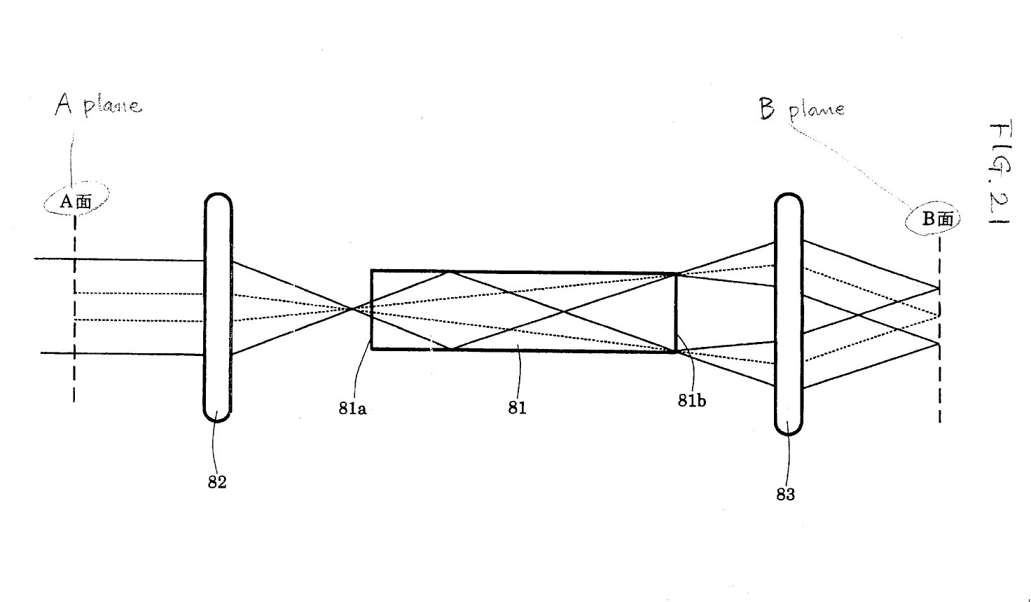

In an exposure apparatus shown in FIG. 1, a wave front dividing type optical integrator (micro lens array 8) is used to form multi-spot secondary light source. An internal reflection type optical integrator (rod type integrator) can be used in place of the wave front dividing type optical integrator (micro lens array 8). FIG. 21 schematically shows a primary structure of an exposure apparatus of FIG. 1 where a rod integrator is used in place of a micro lens array.

In FIG. 21, an input lens 82 are arranged in the optical path between a second variable power optical system 7 and a rod integrator 81, and a relay lens 83 is arranged in the optical path between the rod integrator and a condenser optical system 9 complying with the change that the rod type integrator 81 is arranged in place of the micro lens array 8. A plane and B plane in FIG. 21 correspond respectively to an incident (light-incoming) plane and a light-outgoing plane of a micro lens array 8 in FIG. 1.

The rod type integrator 81 is a glass rod of the internal reflection type composed of a glass material such as silica glass or fluorite. The rod type integrator 81 forms light source images of the number corresponding to the number of times of internal reflection along the plane which passes through the light-collecting point and which is parallel to the rod light-incoming surface, by utilizing the total reflection at the boundary plane between the inside and the outside, i.e., at the internal surface. In this case, almost all of the formed light source images are virtual images. However, only the light source image at the center (light-collecting point) is a real image. That is, the light beam, which comes into the rod type integrator 81, is divided in the angular direction by means of the internal reflection to form the secondary light source composed of a large number of light source images along the plane which contains the light-collecting point and which is parallel to the incident (light-incoming) plane.

The light beam, which has passed through the diffractive optical element 6, forms the multi-spot illumination field on the A plane and then is collected in the vicinity of the incident (light-incoming) surface 81a of the rod type integrator 81 via the input lens 82. The light beams, which come from the multi-spot secondary light sources formed on the light-incoming side of the rod type integrator 81 by itself, are superimposed on the light-outgoing plane 81b to subsequently illuminate the mask (photoreticle) M having a predetermined pattern in a superimposed manner via the relay lens 83 and the condenser optical system 9.

It is possible to set the light-outgoing plane 81b of the rod integrator 81 in the vicinity of the mask M by detaching the relay lens 83 and the condenser optical system 9, or to set the incident (light-incoming) plane 81a of the rod integrator 81 in the vicinity of the light-outgoing plane of the diffractive optical element 6 by detaching the second variable power optical system 7 and the input lens 82. It is also possible to set the light-outgoing plane 81b of the rod integrator 81 in the vicinity of the mask M and to set the incident (light-incoming) plane 81a of the rod integrator 81 in the vicinity of the light-outgoing plane of the diffractive optical element 6 by detaching the second variable power optical system 7, the input lens 82, the relay lens 83 and the condenser optical system 9.

In the exposure apparatus of FIG. 1, an optical delay system, which is disclosed, for example in Japanese unexamined patent application publications H09-205060, H10-125585 and 2000-277421, can be installed in the optical path between the light source 1 and the diffractive optical element 4 as a light beam-diverging element. The case where the optical delay system is placed in the optical path between a bent mirror 3 and the diffractive optical element 4 are explained below.

The light beam, which has been converted into the light beam having predetermined cross section by the aid of a beam modifying system 2 and a bent mirror 3, comes into an optical delay system composed of a total reflecting mirror and a partial reflecting mirror. A part of light beam which has transmitted through the partial reflecting mirror comes into the diffractive optical element 4, and the rest of the light beam (reflected by the partial reflecting mirror) comes into the total reflecting mirror. A light beam reflected by the total reflection mirror comes into the partial reflecting mirror and a part of the light beam which has transmitted through the partial reflecting mirror comes into the diffractive optical element 4, the rest of the light beam which has been reflected by the partial mirror comes into the total reflection mirror.

Thus a multi-reflection made between the total reflecting mirror and the partial reflecting mirror converts incoming light beam sequentially into optically delayed multi-beams. As a result, an interference noise on a conjugate plane on wafer can be reduced. More details of the optical delay system can be referred to, for example, in Japanese unexamined patent application publications H09-205060, H10-125585 and 2000-277421.

In the embodiment disclosed above, binary type diffractive optical element pattern is used. However, other diffractive optical element pattern, such as blaze-type, multi-level-type (multi-level binary type) can be also used. Examples using those types are explained in general referring to FIG. 22.

FIG. 22(a) shows a cross section of a blaze-type ring-shaped diffractive optical element taken along the line containing a center A (B) of ring pattern, FIG. 22(b) is a cross section of a multi-level-type ring-shaped diffractive optical element taken along the line containing a center A (B) of ring pattern and FIG. 22(c) shows a cross section of a binary-type ring-shaped diffractive optical element taken along the line containing a center A (B) of ring pattern. In FIG. 22(a), the cross section of the blaze-type is sawtooth (serrated). A pitch of the sawtooth is defined by the following expression (3).

P=λ/sin θ (3);

wherein θ is predetermined diffraction angle.

A depth d in the cross section is defined by expression (4).

d=λ/(n−1) (4);

wherein n: refractive index of substrate and refractive index of atmospheric gas is assumed 1.

In the present invention, a standard element and a complementary element having such a blaze-type diffractive optical element pattern can be used, where the height of the cross section is not binary (projection/recess) but changes gradually in the height direction. This pattern can be formed by using gray scale mask where transmittance changes gradually.

FIG. 22(b) shows a cross section of multi-level-type is a step-wise version of the sawtooth in the blaze-type, where the number of steps L is three or more. A border between each step is easily defined by dividing a region of one pitch into L parts. FIG. 22(b) shows octal (8-value) phase type diffractive optical element. A depth d L in the cross section is defined by expression (5).

d_{L}=λ×(L−1)/{L×(n−1)} (4);

wherein n: refractive index of substrate and refractive index of atmospheric gas is assumed 1.

In the present invention, a standard element and a complementary element having such a multi-level-type diffractive optical element pattern can be used, where the height of the cross section is not binary (protrusion/recess) but changes multi-level wise in the height direction. This pattern can be formed by using gray scale mask where transmittance changes multi-level wise.

FIG. 22(c) shows a cross section of the binary type diffractive optical element, where the height of the cross section is binary (protrusion region/recessed region), which corresponds to the multi-level-type where L is 2. Consequently a depth d L in the cross section is defined by expression (6).

d₂=λ/{2×(n−1)} (6);

wherein n: refractive index of substrate and refractive index of atmospheric gas is assumed 1.

The embodiment and modified examples which have been described above use a standard element and a complementary element having such a binary type diffractive optical element pattern, i.e. FIG. 22(c) corresponds substantially to FIG. 4(a). In this case, black and white type mask (having only light-transmitting part and light-shielding part) can be used. Quart, crystal and fluorite can be used as materials for the substrate on which diffractive optical element pattern is formed.

In the embodiment above, as a diffracted light radiates symmetrically with respect to a center of binary-type ring-shaped diffraction grating, two types of standard elements are used, that is the first standard element A having a ring-shaped phase diffraction grating formed at A₀ point as a center which is eccentric in the +X direction with respect to the center of the contour S₀ and the second standard element B having a ring-shaped phase diffraction grating formed at B o point as a center which is eccentric in the +Z direction with respect to the center of the contour S₀. In the case of blaze-type or multi-level-type ring-shaped diffraction grating, the diffracted light radiates only in one side with respect to the center. Therefore, another two types of standard elements are needed in addition to the first standard element and the second standard element, that is a third standard element C having a ring-shaped phase diffraction grating formed at C₀ point as a center which is eccentric in the −X direction with respect to the center of the contour S and a fourth standard element D having a ring-shaped phase diffraction grating formed at D₀ point as a center which is eccentric in the −Z direction with respect to the center of the contour S.

Thus, in the case of using blaze-type or multi-level-type ring-shaped diffraction grating in the first modified example, the diffractive optical element is composed of a standard element (A, B; C, D) and a complementary element (Ad, Bd, Cd, Dd). In the case of using blaze-type or multi-level-type ring-shaped diffraction grating in the second modified example. In the case of using blaze-type or multi-level-type ring-shaped diffraction grating in the second modified example, the diffractive optical element is composed of a standard element (A, B, C, D) and a complementary element (Ad1-Ad3, Bd1 Bd3, Cd1-Cd3, Dd1-Dd3). Determining a pattern of complementary element using the blaze-type or multilevel-type ring-shaped diffraction grating can be made by the process that providing the phase differences with respect the pattern of cross section containing the ring center A B based on the principle which is explained by using FIG. 4 and FIG. 18 with respect to FIGS. 22(a) and (b).

Typical manufacturing process for the diffractive optical element used in the above embodiment is briefly explained below. First a pitch of the ring-shaped diffraction grating which is to be formed on the standard element is determined according to the relation between an effective diameter of a light beam, a wave length of light source, a divergence angle of a light beam-diverging element and a focal length of a relay lens which is located between a light source and an optical integrator (micro lens array 8 in the embodiment) which locates closest to a mask. Effective diameters of a standard element and a complementary element are determined so that a plurality of the standard elements or the complementary elements can be included in an element light beam which corresponds to each optical element of which the light beam-diverging element is composed. In the embodiment of FIG. 1, the diffractive optical element 4 corresponds to the light beam-diverging element.

Pattern(s) of complementary element(s) are determined, wherein the complementary element generates an intensity distribution which is the same as a standard element but different in phase. Then pattern of diffractive optical element is determined so that the standard element and one or more types of complementary element are integrated in an effective diameter, wherein the standard elements correspond in number to each type complementary elements. At the same time random arrangement (including partial randomization) of the standard elements and the complementary elements is made.

A wave optical simulation are made with respect to the determined pattern of diffractive optical element to optimize a pitch of the standard element and phase and type of phase of complementary element. Then a mask (reticle) is manufactured based on the optimized pattern. Photoresist-coated glass substrate is exposed with the pattern on the mask. After this, developing, etching and AR (anti-reflection) coating are made.

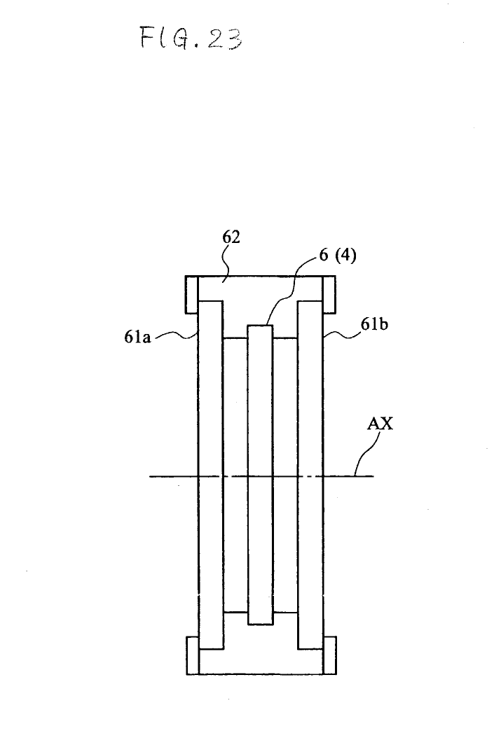

In the exposure apparatus in FIG. 1, a diffractive optical element 4 and a diffractive optical element 6 can be covered with a cover glass. FIG. 23 shows a holder 62 for holding a diffractive optical element 6 (4), on which a pair of cover glasses 61a and 61b are fixed in order to prevent foreign materials from attaching to the diffractive optical element 6 (4) and keep inside much cleaner than outside, which can extend the life of the diffractive optical element 6 (4) located inside.

In the case that a fluence of a large number of light beams radiated from the diffractive optical element 6 (4) is high, which may cause compaction damage on a light-outgoing side cover glass 61b, which leads to uneven illumination. Cover glass should preferably be made of fluorite (CaF). The cover glass can also be made of crystal quartz (SiO) such as crystal and oxide crystal materials such as barium titanate (BaTiO), titanium trioxide (TiO), magnesium oxide (MgO) and sapphire (AlO). If an adverse effect due to the foreign materials to be attached to the diffractive optical element 6 (4) is expected to be very small or relatively smaller than that due to compaction of cover glass, the cover glass can be detached. A refractive optical element 60 used in substitution for the diffractive optical element 6 (4) can be covered with a pair of cover glasses 61a and 61b as well. Fluorite or oxide crystal can be used as a material for both the diffractive optical element and the refractive optical element.

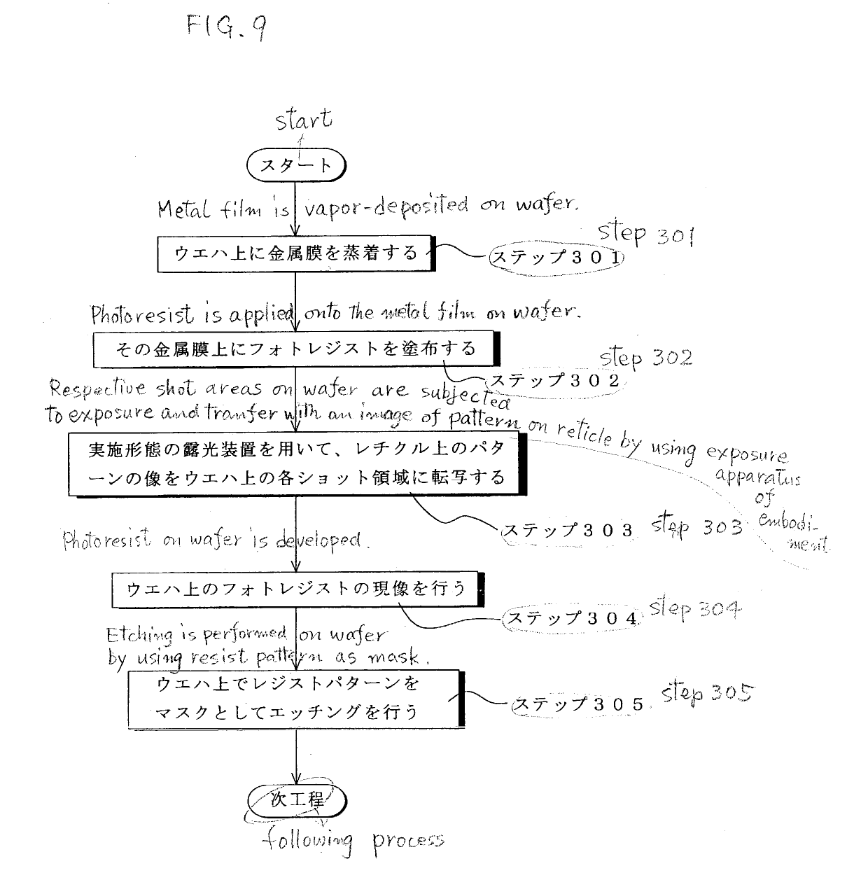

When the exposure apparatus according to each of the embodiments described above is used, it is possible to produce micro-devices (for example, semiconductor devices, image pickup devices, liquid crystal display devices, and thin film magnetic heads) by illuminating the mask (reticle) with the illumination optical apparatus (illuminating step), and projecting an image of a pattern of the mask onto a photosensitive substrate via the projection optical system, in other words, exposing a photosensitive substrate with a transfer pattern formed on the mask by using the projection optical system (exposing step). Explanation will be made below with reference to a flow chart shown in FIG. 9 for an example of the technique adopted when the semiconductor device is obtained as the micro-device by forming a predetermined circuit pattern on the wafer or the like as the photosensitive substrate by using the exposure apparatus illustrated in each of the embodiments described above.

At first, in step 301 in FIG. 9, a metal film is vapor-deposited on one lot of wafers. In the next step 302, a photoresist is applied onto the metal film of one lot of wafers. After that, in step 303, respective shot areas on one lot of wafers are successively subjected to exposure and transfer with an image of a pattern on the mask via the projection optical system by using the exposure apparatus of each of the embodiments described above. After that, in step 304, the photoresist on one lot of wafers is developed, and then etching is performed by using the resist pattern as the mask on one lot of wafers in step 305. Thus, a circuit pattern corresponding to the pattern on the mask is formed on the respective shot areas on the respective wafers. After that, for example, a circuit pattern is formed for further upper layers. Thus, a device such as a semiconductor element is produced. According to the method for producing the semiconductor device described above, the semiconductor device having the extremely fine and minute circuit pattern can be obtained with a good throughput.

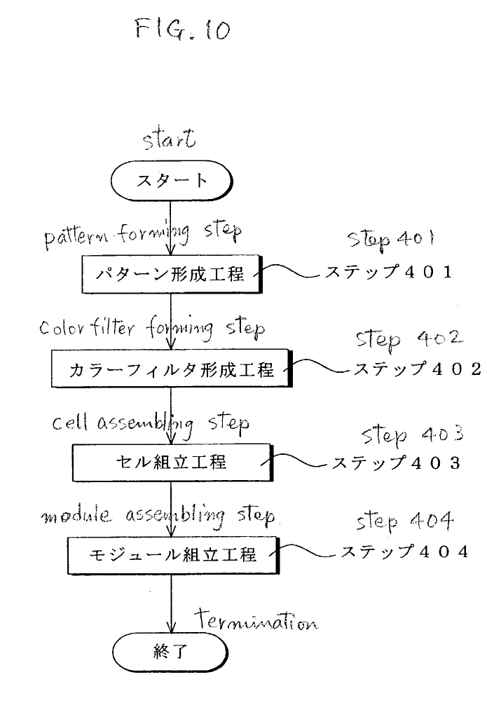

When the exposure apparatus according to each of the embodiments described above is used, a liquid crystal display element as a micro-device can be also obtained by forming a predetermined pattern (for example, a circuit pattern or an electrode pattern) on a plate (glass substrate). An exemplary technique for such a procedure will be explained below with reference to a flow chart shown in FIG. 10. In a pattern-forming step 401 shown in FIG. 10, a so-called lithography step is executed, in which a photosensitive substrate (for example, a glass substrate applied with photoresist) is subjected to transfer and exposure with a pattern on a mask by using the exposure apparatus according to each of the embodiments described above. A predetermined pattern including a large number of electrodes and other components is formed on the photosensitive substrate in accordance with the photolithography step. After that, the exposed substrate is subjected to respective steps including, for example, a development step, an etching step, and reticle-peeling off step. Accordingly, the predetermined pattern is formed on the substrate, and the procedure proceeds to the next color filter-forming step 402.

Subsequently, in the color filter-forming step 402, a color filter is formed, in which a large number of sets of three dots corresponding to R (Red), G (Green), and B (Blue) are arranged in a matrix form, or a plurality of sets of filters of three stripes of R, G, and B are arranged in the horizontal scanning line direction. After the color filter-forming step 402, a cell-assembling step 403 is executed. In the cell-assembling step 403, a liquid crystal panel (liquid crystal cell) is assembled by using, for example, the substrate having the predetermined pattern obtained in the pattern-forming step 401 and the color filter obtained in the color filter-forming step 402. In the cell-assembling step 403, for example, a liquid crystal is injected into the space between the substrate having the predetermined pattern obtained in the pattern-forming step 401 and the color filter obtained in the color filter-forming step 402 to produce a liquid crystal panel (liquid crystal cell).

After that, in a module-assembling step 404, respective parts including, for example, a backlight and an electric circuit for effecting the display action on the assembled liquid crystal panel (liquid crystal cell) are attached to complete the liquid crystal display element. According to the method for producing the liquid crystal display element, it is possible to obtain, with a good throughput, the liquid crystal display element having the extremely fine and minute circuit pattern.

In the embodiment above, Ar F excimer laser for supplying the light having a wavelength of 193 nm or Kr F excimer laser for supplying the light having a wavelength of 248 nm is used as a light source 1. Other light source such as F laser for supplying 157 nm light, mercury lamp for supplying g ray (436 nm) and i ray (365 nm) can be used. In the case of using mercury lamp, light source 1 is constituted by a mercury lamp, an elliptical mirror and a collimator.

In each of the embodiments described above, the present invention has been explained as exemplified by the projection exposure apparatus provided with the illumination optical apparatus. However, it is clear that the present invention is applicable to a general illumination optical apparatus for illuminating an illumination plane other than the mask.

The diffractive optical element of the invention includes a first basic diffractive element where a ring-shaped diffraction grating is formed being eccentric with respect to a center of outer shape in the first direction, and a second basic diffractive element where a ring-shaped diffraction grating is formed being eccentric with respect to a center of outer shape in the second direction. Therefore, peak and valley in the light intensity distribution make up for each other to provide flat intensity distribution with less dependency on angle of direction.

Therefore, an illuminating optical apparatus having the diffractive optical element of the present invention can form a substantially uniform annular illuminance distribution on both an illumination plane and an illumination pupil plane, which leads to making a good annular illumination with less loss of light beam amount.

An exposure apparatus and an exposure method using illuminating optical apparatus of the present invention are capable of making high-fidelity transfer of a mask pattern onto a photosensitive substrate under the optimal illumination condition for the mask by using an illuminating optical apparatus capable of providing a good annular illumination with less loss of light beam amount. An exposure apparatus and an exposure method of the present invention, which are capable of making high-fidelity transfer of a mask pattern onto a photosensitive substrate, can manufacture good high quality micro-devices.

What is claimed is:

1. A diffractive optical element comprising:
a first basic diffractive element on which a ring-shaped diffraction grating is formed, and
a second basic diffractive element on which a ring-shaped diffraction grating is formed,
wherein a center of the ring-shaped diffraction grating of the first basic diffractive element is eccentric in the first direction with respect to the center of a contour of the first basic diffractive element and a center of the ring-shaped diffraction grating of the second basic diffractive element is eccentric in the second direction with respect to the center of a contour of the second basic diffractive element.

2. A diffractive optical element according to claim 1, wherein the first direction and the second direction are substantially perpendicular to each other.

3. A diffractive optical element according to claim 2, wherein an eccentricity of the center of the ring-shaped diffraction grating of the first basic diffractive element in the first direction is substantially equal to that of the second basic diffractive element in the second direction.

4. A diffractive optical element according to claim 3, wherein the first basic diffractive element and the second basic diffractive element have the same square contour of which one side is L in length, and the eccentricity A meets the following condition;
0.28L<Δ<0.30L

5. A diffractive optical element according to claim 1, wherein the number of the first basic diffractive element is substantially equal to the number of the second basic diffractive element.

6. A diffractive optical element according to claim 5, wherein the first basic diffractive element and the second basic diffractive element are alternately adjacently arrayed in the diffractive optical element.

7. A diffractive optical element according to claim 1, wherein:
the first basic diffractive element includes a first standard element on which a circular region and annular regions defined by concentric circles are formed where even-numbered regions are protrusion areas and a first complementary element on which a circular region and annular regions defined by concentric circles are formed where odd-numbered regions are protrusion areas assuming that a center is in odd-numbered region 1, and
the second basic diffractive element includes a second standard element on which a circular region and annular regions defined by concentric circles are formed where even-numbered regions are protrusion areas and a second complementary element on which a circular region and annular regions defined by concentric circles are formed where odd-numbered regions are protrusion areas assuming that a center is in odd-numbered region 1,

8. A diffractive optical element according to claim 7, wherein the number of the first standard element is substantially equal to the number of the first complementary element and the number of the second standard element is substantially equal to the number of the second complementary element.

9. A diffractive optical element according to claim 7, wherein:
the first standard element and the second standard element are adjacently arranged to form a standard block composed of the first standard element and the second standard element,
the first complementary element and the second complementary element are adjacently arranged to form a complementary block composed of the first complementary element and the second complementary element,
the number of the standard block is substantially equal to the number of the complementary block, and
the standard block and the complementary block are arranged spatially in a random order.

10. A diffractive optical element according to claim 7, wherein a diameter of the circular region is substantially equal in dimension to a width of the each annular region.

11. A diffractive optical element according to claim 6, wherein:
the first basic diffractive element includes a first standard element and n types of first complementary elements, where n represents positive integer,
the second basic diffractive element includes a second standard element and n types of second complementary elements, where n represents positive integer, and
the first complementary element and the second complementary element of i^{th} phase (i=1 to n) have a pattern which radiate a light field of i^{th} phase difference with respect to a light field radiated by the first standard element and the second standard element.

12. A diffractive optical element according to claim 11, wherein the first basic diffractive element and the second basic diffractive element have a plurality of types of the complementary elements respectively, and the i^{th} phase difference is changed with substantially the same phase interval.

13. A diffractive optical element according to claim 12, wherein the i^{th} phase difference between the first standard element and the first complementary element of the i^{th} phase and the i^{th} phase difference between the second standard element and the second complementary element of the i^{th} phase are substantially a wave length of i/(n+1).

14. A diffractive optical element according to claim 11, wherein the diffractive optical element includes a plurality of the first standard element, a plurality of the second standard element, a plurality of the first complementary element of the i^{th} phase and a plurality of the second complementary element of i^{th} phase.

15. A diffractive optical element according to claim 14, wherein a plurality of the first standard elements, a plurality of the second standard elements, a plurality of the first complementary elements of i^{th} phase and a plurality of the second complementary elements of i^{th} phase are substantially the same in number with respect to all of i.

16. A diffractive optical element according to claim 15, wherein a plurality of the first standard element, a plurality of the second standard element, a plurality of the first complementary element of i^{th} phase and a plurality of the second complementary element of i^{th} phase are randomly arranged all over the diffractive optical element.

17. A diffractive optical element according to claim 15, wherein the diffractive optical element has a plurality of block patterns in each of which a plurality of the first standard element, a plurality of the second standard element, a plurality of the first complementary element of i^{th} phase and a plurality of the second complementary element of i^{th} phase are randomly arranged.

18. A diffractive optical element according to claim 17, wherein a plurality of the first standard elements, a plurality of the second standard elements, a plurality of the first complementary elements of i^{th} phase and a plurality of the second complementary elements of i^{th} phase are substantially the same in number with respect to all of i in each of the block patterns.

19. A diffractive optical element according to claim 17, wherein each block pattern has a different type of random arrangement from others.

20. A diffractive optical element according to claim 1, wherein the ring-shaped diffraction grating has any one of patterns, binary type, blaze type or multi-level-type.

21. A refractive optical element comprising:
a first basic refractive element composed of conical prism, and
a second basic refractive element composed of conical prism, wherein a center axis of the conical prism of the first basic refractive element is eccentric in the first direction with respect to the center of a contour of the first basic refractive element and a center axis of the conical prism of the second basic refractive element is eccentric in the second direction with respect to the center of a contour of the second basic refractive element.

22. A refractive optical element according to claim 21, wherein the first direction and the second direction are substantially perpendicular to each other.

23. A refractive optical element according to claim 22, wherein an eccentricity of the center axis of the conical prism of the first basic refractive element in the first direction is substantially equal to that of the second basic refractive element in the second direction.

24 A refractive optical element according to claim 21, wherein the number of the first basic refractive element is substantially equal to the number of the second basic refractive element.

25. A refractive optical element according to claim 21, wherein the first basic refractive element and the second basic refractive element are alternately adjacently arrayed in the refractive optical element.

26. An illuminating optical apparatus for illuminating an illumination plane comprising:
a diffractive optical element according to claim 1 for converting incoming light beam into a ring shape light beam so that a secondary light source having an annular light intensity distribution can be formed on illumination pupil plane.

27. An illuminating optical apparatus for illuminating an illumination plane comprising:
a refractive optical element according to claim 21 for converting incoming light beam into a ring shape light beam so that a secondary light source having an annular light intensity distribution can be formed on illumination pupil plane.

28. An illuminating optical apparatus according to claim 26, further comprising:
a light source,
an angled-light-beam forming means for converting the light beam from the light source into a light beam having a variety of angle components with respect to the optical axis and sending the light beam into predetermined first plane,
an illumination field forming means including the diffractive optical element for forming an annular illumination field on a second predetermined plane based on the light beam having a variety of angle components with respect to the optical axis,
an optical integrator for forming an annular secondary light source having substantially the same light intensity distribution as the annular illumination field, and
a light guiding optical system for guiding a light beam from the optical integrator to the illumination plane.

29. An illuminating optical apparatus according to claim 27, further comprising:
a light source,
an angled-light-beam forming means for converting the light beam from the light source into a light beam having a variety of angle components with respect to the optical axis and sending the light beam into predetermined first plane,
an illumination field forming means including the refractive optical element for forming an annular illumination field on a second predetermined plane based on the light beam having a variety of angle components with respect to the optical axis,
an optical integrator for forming an annular secondary light source having substantially the same light intensity distribution as the annular illumination field, and
a light guiding optical system for guiding a light beam from the optical integrator to the illumination plane.

30. An illuminating optical apparatus according to claim 28, wherein:
the angled-light-beam forming means includes an optical member composed of a plurality of optical elements, and
the diffractive optical element is arranged so that a plurality of basic diffractive elements can be included in an element light beam which corresponds to each optical element of the optical member.

31. An illuminating optical apparatus according to claim 29, wherein:
the angled-light-beam forming means includes an optical member composed of a plurality of optical elements, and
the refractive optical element is arranged so that a plurality of basic refractive elements can be included in an element light beam which corresponds to each optical element of the optical member.

32. An illuminating optical apparatus according to claim 28, wherein:
the angled-light-beam forming means includes an optical member composed of a plurality of optical elements, and
the diffractive optical element is arranged so that a combination of the first basic diffractive element and the second basic diffractive element can be included in an element light beam which corresponds to each optical element of the optical member.

33. An illuminating optical apparatus according to claim 29, wherein:
the angled-light-beam forming means includes an optical member composed of a plurality of optical elements, and
the refractive optical element is arranged so that a combination of the first basic refractive element and the second basic refractive element can be included in an element light beam which corresponds to each optical element of the optical member.

34. An exposure apparatus comprising:
an illuminating optical apparatus according to claim 26, and a light projection optical system for projecting an image of a pattern of a mask
disposed on the illumination plane onto a photosensitive substrate.

35. An exposure apparatus comprising:
an illuminating optical apparatus according to claim 27, and
a light projection optical system for projecting an image of a pattern of a mask disposed on the illumination plane onto a photosensitive substrate.

36. An exposure method comprising steps of:
illuminating a mask via an illumination optical device according to claim 26, and projecting an image of a pattern formed on the mask onto a photosensitive substrate.

37. An exposure method comprising steps of:
illuminating a mask via an illumination optical device according to claim 27, and projecting an image of a pattern formed on the mask onto a photosensitive substrate.

38. A diffractive optical apparatus including a diffractive optical element for converting incoming light beam into a predetermined outgoing light beam comprising:
a protecting member, which transmit a light, disposed in the light beam incoming side and/or light beam outgoing side of the diffractive optical element, wherein the protecting member is made of fluorite or oxide crystal.

39. A diffractive optical element according to claim 1, wherein a pitch in a cross section of the ring-shaped diffractive grating is constant.

40. A diffractive optical element according to claim 20, wherein a pitch in a cross section of the ring-shaped diffractive grating is constant.
